(19) United States
(12) Patent Application Publication
(10) Pub. No.: US 2025/0125396 A1
(43) Pub. Date: Apr. 17, 2025

(54) POLYMER ELECTROLYTE MEMBRANE, MEMBRANE ELECTRODE ASSEMBLY AND REDOX FLOW BATTERY

(71) Applicant: W. L. Gore & Associates, Inc., Newark, DE (US)

(72) Inventors: Peter W. Hosbein, Newark, DE (US); Alexander L. Agapov, Newark, DE (US)

(21) Appl. No.: 18/568,487

(22) PCT Filed: Jun. 13, 2022
(86) PCT No.: PCT/IB2022/055463

§ 371 Date: Dec. 8, 2023

Related U.S. Application Data
(60) Provisional application No. 63/210,080, filed on Jun. 14, 2021.

(51) Int. Cl. H01M 8/1053; C25B 13/08; H01M 4/96; H01M 8/10; H01M 8/1004; H01M 8/1025; H01M 8/1032; H01M 8/1039; H01M 8/1048; H01M 8/1067; H01M 8/18

(52) U.S. Cl. CPC H01M 8/1053; H01M 4/96; H01M 8/1004; H01M 8/1025; H01M 8/1032; H01M 8/1039; H01M 8/1048; H01M 8/1067; H01M 8/188; C25B 13/08; H01M 2008/1095

(57) ABSTRACT

There is provided a composite electrolyte membrane for an electrochemical device, comprising at least one reinforced polymer electrolyte membrane having a first surface and an opposing second surface. The reinforced polymer electrolyte membrane comprises a microporous polymer structure and an ion exchange material, in which the ion exchange material is at least partially embedded within the microporous polymer structure to render the microporous polymer structure occlusive. The composite electrolyte membrane further comprises a plurality of porous layers comprising a first porous layer and a second porous layer, in which the first porous layer is adjacent to the first surface of the first reinforced polymer electrolyte and the second porous layer is adjacent to the second surface of the reinforced polymer electrolyte. Also disclosed is a membrane electrode assembly comprising such a composite electrolyte membrane and a redox flow battery, fuel cell, and electrolyzer comprising such a membrane electrode assembly.

### CROSS-REFERENCE TO RELATED APPLICATION

This application is a national phase application of PCT Application No. PCT/IB2022/055463, internationally filed on Jun. 13, 2022, which claims the benefit of U.S. Provisional Application No. 63/210,080, filed Jun. 14, 2021, which are herein incorporated by reference in their entireties for all purposes.

### FIELD

This disclosure relates to a composite electrolyte membrane for an electrochemical device, such as a redox flow battery. The composite electrolyte membrane comprises a reinforced polymer electrolyte membrane and a plurality of porous layers comprising a first porous layer and a second porous layer, the first and second porous layers adjacent to opposing surfaces of the reinforced polymer electrolyte membrane. Also disclosed is a membrane electrode assembly comprising such a composite electrolyte membrane and a fuel cell, electrolyzer and redox flow battery comprising such a membrane electrode assembly. Such composite electrolyte membranes exhibit a high resistance to piercing. Consequently, a redox flow battery comprising such a composite electrolyte membrane has improved resistance to electrical shorting.

### BACKGROUND

Polymer Electrolyte Membranes (PEMs) are critical components in many applications, such as fuel cells, electrolyzers, redox flow batteries, and humidifiers. They are semipermeable membranes made from an ion exchange material, such as ionomers which are polymers which contain covalently bonded pendant ionized units. PEMs are designed to conduct ions such as protons whilst being an electronic insulator and having a low permeance to reactants such as gaseous oxygen and hydrogen or otherionic species.

In Polymer Electrolyte Membrane Fuel Cells (PEMFCs) and humidifiers, the PEM is part of a Membrane Electrode Assembly (MEA). The MEA is the core component of the fuel cell where the electrochemical reactions take place that generate power. A typical MEA comprises a PEM, two catalyst layers (i.e., the anode and the cathode, which are attached to opposite sides of the PEM), and two gas diffusion layers (GDLs, which are attached to the outer surfaces of each catalyst layers, opposite to that adjacent to the PEM). The PEM separates two reactant gas streams. On the anode side of the MEA, a fuel, e.g., hydrogen gas, is oxidized to separate the electrons and protons. The cell is designed so that the electrons travel through an external circuit while the protons migrate through the PEM. On the cathode side the electrons and protons react with an oxidizing agent (i.e., oxygen or air) to produce water and heat. In this manner, an electrochemical potential is maintained and current can be drawn from the fuel cell to perform useful work.

Electrolyzers hydrolyze water to generate hydrogen and oxygen. The reactions that take place in an electrolyzer are very similar to the reaction in fuel cells, except the reactions that occur in the anode and cathode are reversed. In a fuel cell the anode is where hydrogen gas is consumed and in an electrolyzer the hydrogen gas is produced at the cathode. Bipolar electrolyzers (or PEM electrolyzers) use the same type of electrolyte as PEM fuel cells. The electrolyte is a thin, solid ion-conducting membrane, which is used instead of the aqueous solution employed in alkaline electrolyzers.

Redox flow batteries use two soluble redox couples as electroactive materials to store and release energy via oxidation and reduction reactions. Typically, the redox flow batteries comprise two electrolyte reservoirs (a catholyte and an anolyte) from which the electrolytes are circulated by pumps through an electrochemical cell stack. The cell stack usually comprises multiple cells connected in series or parallel to enable electrochemical reactions to take place at inert electrodes. Each cell of the stack comprises an anode, a cathode and an ion exchange membrane separator (such as a polymer electrolyte membrane) to allow the selective diffusion of ions (e.g. protons) across the membrane separator while preventing the cross-mixing of the electrolyte solutions from the two reservoirs.

High selectivity (via high conductance of desirable species and/or low permeance for undesirable species), high durability, and low cost, are all desirable qualities in a PEM. However, as a matter of practical engineering, conflicts often arise in the optimization of these properties, requiring tradeoffs to be accepted. One can attempt to improve selectivity by increasing the conductance of selected ions (e.g. protons) via reduction in membrane thickness. Making a PEM thinner also lowers its cost because the ion exchange material is expensive and less of it is used. However, thinner membranes have increased permeation (e.g. to hydrogen gas or undesirable ionic species), which erodes any selectivity gains from increased proton conduction, and results in thinner membranes having similar or worse selectivity than thicker ones. In addition, thinner membranes also are weaker, frequently lacking sufficient mechanical durability for aggressive automotive conditions. Reducing the thickness of polymer electrolyte membranes can also increase the susceptibility to damage or puncture from other electrochemical device components, leading to shorter cell lifetimes.

One example of mechanical weakness is the piercing of PEMs. Electrode layers may comprise a microporous layer (typical pore size 1-200 micron), particularly in RFBs. The microporous layer may comprise, among others, a felt, a paper, a mat or a woven material which can be made of fibrous material. During PEM-electrode assembly, the electrodes are compressed against the PEM. The fibrous material forming the electrode layers, such as carbon fibers, can pierce the PEM upon compression. This can be particularly problematic in Redox Flow Batteries (RFB) in which fibrous electrode layers are disposed one either side of the PEM.

Thus, PEM electrochemical devices can fail because pinholes formed by piercing damage may propagate through the polymer electrolyte membranes. In addition, these devices can also fail if electronic current passes through the PEMs, conducted through the pinholes by the electrolyte causing the systems to short.

Therefore, the provision of membranes with higher proton conductance, typically by using thinner membranes, is limited by the need to provide piercing resistance, typically by using thicker membranes.

A known approach to improving the mechanical resistance and resistance to piercing properties of PEMs involves protecting the PEM with a transport protection layer. However, even protected PEMs can be subject to piercing upon assembly of the PEM during electrochemical device fabrication.

Accordingly, a need exists for thin composite membranes that retain good performance and low ionic resistance while presenting improved resistance to piercing by the electrochemical device components and corresponding improved resistance to electrical shorting compared to known composite membranes.

### SUMMARY

This disclosure addresses the problems mentioned above. It has been surprisingly discovered that a composite electrolyte membrane comprising a) at least one reinforced polymer electrolyte membrane comprising a first reinforced polymer electrolyte membrane and b) a plurality of porous layers comprising a first porous layer and a second porous layer adjacent to opposing surfaces of the first reinforced polymer electrolyte membrane provides increased the resistance to piercing of the PEM by components of electrochemical devices upon device fabrication. Each of the plurality of porous layers have a plurality of pores having a pore size in the range of from 5 micrometers to 5000 micrometers. Each of the plurality of porous layers provide one or more passages extending between the first and second surfaces of the porous layer. Thus, the first porous layer has a plurality of pores having a pore size in the range of from 5 micrometers to 5000 micrometers, and the plurality of pores provide one or more passages extending between the first and second surfaces of the first porous layer. Similarly, the second porous layer has a plurality of pores having a pore size in the range of from 5 micrometers to 5000 micrometers, and the plurality of pores provide one or more passages extending through the second porous layer between the first and second surfaces of the second porous layer.

Furthermore, such increased resistance to piercing may be achieved whilst retaining a low proton sheet resistance. These discoveries are highly beneficial, because, compared with known composite electrolyte membranes, the composite electrolyte membranes described herein present superior resistance to piercing by components of the electrochemical devices in which the composite electrolyte membrane can be integrated. Therefore, the composite membranes described herein have superior resistance to piercing by elements of electrochemical devices upon device fabrication, without compromising the performance of the membranes. The superior piercing resistance of the composite membranes described herein is apparent from their improved shorting and burst pressures.

In a first aspect there is provided a composite electrolyte membrane for an electrochemical device, comprising:
a) at least one reinforced polymer electrolyte membrane having a first surface and an opposing second surface, said at least one reinforced polymer electrolyte membrane comprising:
a microporous polymer structure and an ion exchange material, in which the ion exchange material is at least partially embedded within the microporous polymer structure to render the microporous polymer structure occlusive; and
b) a plurality of porous layers comprising a first porous layer and a second porous layer,
the first porous layer having a first surface and an opposing second surface such that the first surface of the first porous layer is adjacent to the first surface of the at least one reinforced polymer electrolyte membrane, wherein the first porous layer has a plurality of pores having a pore size in the range of from 5 micrometers to 5000 micrometers, and the plurality of pores provide one or more passages extending between the first and second surfaces of the first porous layer,
the second porous layer having a first surface and an opposing second surface such that the first surface of the second porous layer is adjacent to the second surface of the at least one reinforced polymer electrolyte membrane, wherein the second porous layer has a plurality of pores having a pore size in the range of from 5 micrometers to 5000 micrometers, and the plurality of pores provide one or more passages extending through the second porous layer between the first and second surfaces of the second porous layer.

In one embodiment, the at least one reinforced polymer electrolyte membrane comprises a first reinforced polymer electrolyte membrane having a first surface and an opposing second surface.

Each of the plurality of porous layers may have a first surface and an opposing second surface. The plurality of pores provide one or more passages extending between the first and second surfaces of the porous layer. These one or more passages may be regularly or irregularly, preferably regularly, spaced across one or both of the first and second surfaces, preferably both, of the plurality porous layers.

In another embodiment, each of said plurality of porous layers has a thickness at 0% RH in the range of from about 15 μm to about 500 μm or from about 15 μm to about 250 μm or from about 15 μm to about 200 μm or from about 15 μm to about 150 μm or from about 15 μm to about 100 μm or from about 15 μm to about 50 μm or from about 30 μm to about 500 μm or from about 30 μm to about 250 μm or from about 30 μm to about 150 μm or from about 30 μm to about 100 μm or from about 30 μm to about 50 μm or from about 50 μm to about 500 μm or from about 50 μm to about 250 μm or from about 50 μm to about 200 μm or from about 50 μm to about 150 μm or from about 50 μm to about 100 μm

In another embodiment of the composite electrolyte membrane, the microporous polymer structure may be fully embedded within the ion exchange material.

In another embodiment of the composite electrolyte membrane, the microporous polymer structure of the reinforced polymer electrolyte membrane has a first surface and an opposing second surface; and at least one layer of ion exchange material is present on at least one of the first surface and the second surface of the microporous polymer structure. Typically, a layer of ion exchange material may be present on each of the first surface and the second surface of the microporous polymer structure, such that a first layer of ion exchange material is present on a first surface of the microporous polymer structure and a second layer of ion exchange material is present on the second surface of the microporous polymer structure. Preferably, a portion of one or both of the first and second porous layers is partially embedded in the layer of ion exchange material.

In another embodiment, at least one further layer of ion exchange material is present on one or both of the first layer of ion exchange material and a second layer of ion exchange material.

In another embodiment, one or more layers of ion exchange material, such as the at least one layer of ion exchange material and/or the at least one further layer of ion exchange material, may further comprise at least one membrane catalyst. The at least one catalyst may comprise a first catalyst comprising one or more of Pt, Ir, Ni, Co, Pd, Ti, Sn, Ta, Nb, Sb, Pb, Mn, Ru and Fe, their oxides, and mixtures thereof. In an embodiment, the at least one membrane catalyst may comprise a first membrane catalyst and the first layer of ion exchange material may comprise the first membrane catalyst. In an embodiment, the at least one membrane catalyst may comprise a first membrane catalyst and the second layer of ion exchange material may comprise the first membrane catalyst. In an embodiment, the at least one membrane catalyst may comprise a first membrane catalyst and the at least one further layer of ion exchange material may comprise the first membrane catalyst. In an embodiment, the at least one membrane catalyst may be present on a support, such as a carbon particulate.

In another embodiment, one or both of the first and second porous layers may be attached to the reinforced polymer electrolyte membrane. For instance a portion of portion of one or both of the first and second porous layers may be partially embedded in the at least one layer of ion exchange material.

In another embodiment, the at least one reinforced polymer electrolyte membrane may comprise two or more microporous polymer structures. The two or more microporous polymer structures may comprise a first microporous polymer structure and a second microporous polymer structure. A pair of adjacent microporous polymer structures, such as a first microporous polymer structure and a second microporous polymer structure, may be separated by a layer of ion exchange material.

The layer of ion exchange material may have a thickness at 0% RH in the range of from about 0.5 μm to about 20 μm or from about 0.5 μm to about 15 μm or from about 0.5 μm to about 12 μm or from about 0.5 μm to about 8 μm or from about 0.5 μm to about 5 μm or from about 2 μm to about 20 μm or from about 2 μm to about 15 μm or from about 2 μm to about 12 μm or from about 2 μm to about 8 μm or from about 2 μm to about 5 μm.

In one embodiment of the composite electrolyte membrane, the microporous polymer structure in which the ion exchange material has been at least partially embedded to render the microporous polymer structure occlusive has a thickness at 0% RH in the range of from about 0.5 μm to about 500 μm or from about 0.5 μm to about 250 μm or from about 0.5 μm to about 100 μm

In another embodiment of the composite electrolyte membrane, such as where the composite electrolyte membrane is for a redox flow battery, the microporous polymer structure in which the ion exchange material has been at least partially embedded to render the microporous polymer structure occlusive has a thickness at 0% RH in the range of from about 0.5 μm to about 30 μm or from about 0.5 μm to about 21 μm or from about 0.5 μm to about 10 μm or from about 0.5 μm to about 8 μm or from about 0.5 μm to about 6 μm or from about 2 μm to about 30 μm or from about 2 μm to about 21 μm or from about 2 μm to about 10 μm or from about 2 μm to about 8 μm or from about 2 μm to about 6 μm.

In an embodiment of the composite electrolyte membrane, such as where the composite electrolyte membrane is for an electrolyzer, the microporous polymer structure in which the ion exchange material has been at least partially embedded to render the microporous polymer structure occlusive has a thickness at 0% RH in the range of from about 30 μm to about 100 μm or from about 30 μm to about 250 μm or from about 30 μm to about 500 μm.

In another embodiment of the composite electrolyte membrane, the microporous polymer structure may be a microporous polymer membrane.

The microporous polymer structure, such as a microporous polymer membrane, may comprise at least one fluorinated polymer. The at least one fluorinated polymer may be selected from the group comprising polytetrafluoroethylene (PTFE), poly(ethylene-co-tetrafluoroethylene) (EPTFE), expanded polytetrafluoroethylene (ePTFE), polyvinylidene fluoride (PVDF), expanded polyvinylidene fluoride (ePVDF), expanded poly(ethylene-co-tetrafluoroethylene) (eEPTFE) or mixtures thereof. Preferably, the fluorinated polymer may be perfluorinated expanded polytetrafluoroethylene (ePTFE).

Alternatively or additionally, the microporous polymer structure, such as a microporous polymer membrane, may comprise at least one hydrocarbon polymer. The at least one hydrocarbon polymer may be selected from the group comprising polyethylene, polypropylene, polycarbonate, polystyrene, or mixtures thereof.

In another embodiment, the microporous polymer structure, before the ion exchange material has been at least partially embedded within it, may have a thickness at 0% RH in the range of from about 2 μm to about 150 μm or from about 2 μm to about 100 μm or from about 2 μm to about 70 μm or from about 2 μm to about 40 μm or from about 2 μm to about 20 μm. It will be apparent that upon at least partially embedding an ion exchange material within the microporous polymer structure, the thickness of the microporous polymer structure is reduced due to compaction of the microporous polymer structure as its pores are filled and it becomes occlusive.

In another embodiment, the microporous polymer structure, before the ion exchange material has been at least partially embedded, may have a mass per area in the range of from about 0.5 g/m² to about 100 g/m² or from 0.5 g/m² to about 30 g/m² or from about 0.5 g/m² to about 21 g/m² or from about 0.5 g/m² to about 10 g/m² or from about 0.5 g/m² to about 8 g/m² or from about 0.5 g/m² to about 6 g/m² or from about 2 g/m² to about 30 g/m² or from about 2 g/m² to about 21 g/m² or from about 2 g/m² to about 10 g/m² or from about 2 g/m² to about 8 g/m² or from about 2 g/m² to about 6 g/m² or from about 30 g/m² to about 100 g/m² or from about 30 g/m² to about 80 g/m² or from about 30 g/m² to about 60 g/m².

In another embodiment of the composite electrolyte membrane, the ion exchange material comprises at least one ionomer. Preferably, the at least one ionomer comprises a proton conducting polymer. The proton conducting polymer may comprise perfluorosulfonic acid.

In another embodiment of the composite electrolyte membrane, the at least one ionomer has a density not lower than about 1.9 g/cc at 0% relative humidity.

In another embodiment of the composite electrolyte membrane, the average equivalent volume of the ion exchange material is from about 240 cc/mole eq to about 1000 cc/mole eq or the average equivalent volume of the ion exchange material is from about 240 cc/mole eq to about 650 cc/mole eq or the average equivalent volume of the ion exchange material is from about 240 cc/mole eq to about 475 cc/mole eq or the average equivalent volume of the ion exchange material is from about 350 cc/mole eq to about 475 cc/mole eq.

In another embodiment, the microporous polymer structure of the at least one reinforced polymer electrolyte membrane is partially embedded within the ion exchange material. For instance, the microporous polymer structure may have a non-occlusive portion closest to the first surface, second surface or both surfaces of the at least one reinforced polymer electrolyte membrane. The non-occlusive portion may be a portion of the microporous polymer structure which is free of any ion exchange material. Alternatively, the non-occlusive portion may be a portion of the microporous polymer structure which comprises a coating of ion exchange material to an internal surface of the microporous polymer structure, but no ion exchange material on an external surface of the microporous polymer structure (i.e. the composite membrane does not comprise any layers of unreinforced ion exchange material but it may comprise ion exchange material coating the surface of the interior voids, such as interior fibrils, of the microporous polymer structure). In other words, the at least one reinforced polymer electrolyte membrane does not comprise as surface layer of ion exchange material also known as a butter coat on one or both opposing exterior surfaces.

In one embodiment, the reinforced polymer electrolyte membrane may have a thickness at 0% RH in the range of from 2 micrometers to 500 micrometers.

In another embodiment, the reinforced polymer electrolyte membrane has a thickness at 0% RH in the range of from 4 micrometers to 30 micrometers.

In another embodiment of the composite electrolyte membrane, each of the plurality of porous layers may be independently selected from woven material and non-woven material. Examples of non-woven materials include a mesh, knitted material, paper, felt, mat and cloth. More preferably, the plurality of porous layers is woven material, such as a woven material having a leno weave. Such woven material and non-woven material may be made from fiber or fibrous material, preferably a fibrous polymer or metal wire or metal alloy wire. The plurality of porous layers may be metallic meshes such as metallic scrims.

Preferably, a porous layer of the plurality of porous layers, and for instance fiber or fibrous material forming such a layer, may comprise at least one fluorinated polymer. Preferably, the fluorinated polymer may comprise polytetrafluoroethylene (PTFE), poly(ethylene-co-tetrafluoroethylene) (EPTFE), polyvinylidene fluoride (PVDF) or mixtures thereof. More preferably, the fluorinated polymer is polytetrafluoroethylene (PTFE). In another embodiment, a porous layer of the plurality of porous layers, for instance fibrous material forming such a layer, may comprise a hydrocarbon polymer. Preferably, the hydrocarbon polymer may comprise polyethylene, polypropylene, polycarbonate, polystyrene, or mixtures thereof. In another embodiment, a porous layer of the plurality of porous layers may comprise a glass fiber. In another embodiment, a porous layer of the plurality of porous layers may comprise a ceramic material. Preferably, the ceramic material may comprise silica, zirconia, alumina, calcium oxide, magnesium oxide, boron oxide, sodium oxide, potassium oxide, or any mixtures thereof.

In another embodiment, the pore size of a porous layer of the plurality of porous layers may be preferably in the range of from 100 microns to 2000 micrometers or from 500 micrometers to 1500 micrometers.

In another embodiment of the composite electrolyte membrane, each of said plurality of porous layers may have a thickness at 0% RH in the range of from about 15 μm to about 500 μm or from about 15 μm to about 250 μm or from about 15 μm to about 200 μm or from about 15 μm to about 150 μm or from about 15 μm to about 100 μm or from about 15 μm to about 50 μm or from about 30 μm to about 500 μm or from about 30 μm to about 250 μm or from about 30 μm to about 150 μm or from about 30 μm to about 100 μm or from about 30 μm to about 50 μm or from about 50 μm to about 500 μm or from about 50 μm to about 250 μm or from about 50 μm to about 200 μm or from about 50 μm to about 150 μm or from about 50 μm to about 100 μm.

In another embodiment of the composite electrolyte membrane, each of said plurality of porous layers may have an air permeability of greater than 6000 l/hr at a differential pressure of 12 mbar for an open area of 2.99 cm². The air permeability may be measured from the formulas²*100/(C1*C2) where s is the side length of an opening, and C1 and C2 are vertical and horizontal spacings of openings.

In another embodiment of the composite electrolyte membrane, each of said plurality of porous layers may have an open area porosity of from 0.80 to 0.98. Preferably each of said plurality of porous layers has an open area porosity of from −0.93 to 0.97. The open area porosity may be measured by image analysis, such as ImageJ image analysis.

It is preferred that each of the plurality of porous layers is a non-electrically conductive porous layer. The plurality of porous layers may be free from electrically conductive material.

In another embodiment of the composite electrolyte membrane, the composite electrolyte membrane i.e. the at least one reinforced polymer electrolyte membrane and the plurality of porous layers etc. may have a thickness at 0% RH in the range of from about 30 μm to about 1500 μm or from about 30 μm to about 1250 μm or from about 30 μm to about 1100 μm or from about 30 μm to about 800 μm or from about 30 μm to about 500 μm or from about 30 μm to about 300 μm or from about 30 μm to about 250 μm or from about 30 μm to about 150 μm or from about 60 μm to about 1500 μm or from about 60 μm to about 1250 μm or from about 60 μm to about 1100 μm or from about 60 μm to about 800 μm or from about 60 μm to about 500 μm or from about 60 μm to about 300 μm or from about 60 μm to about 250 μm or from about 60 μm to about 150 μm or from about 100 μm to about 1500 μm or from about 100 μm to about 1250 μm or from about 100 μm to about 1100 μm or from about 100 μm to about 800 μm or from about 100 μm to about 500 μm or from about 100 μm to about 300 μm or from about 100 μm to about 250 μm or from about 100 μm to about 150 μm.

In another embodiment of the composite electrolyte membrane, the composite electrolyte membrane is an integral structure. For instance, the at least one reinforced polymer electrolyte membrane may be adhered to the plurality of porous layers. For example, the at least one reinforced polymer electrolyte membrane may comprise a layer of ion exchange material on an exterior surface of the microporous polymer structure, and one of the plurality of porous layers may be partially embedded in the layer or ion exchange material.

In another embodiment of the composite electrolyte membrane, the proton resistance normalized tensile strength, also referred to as proton area specific resistance normalized tensile strength, of the composite electrolyte membrane is ≥2500 MPa/(Ohm·cm²) or is ≥3500 MPa/(Ohm·cm²) or is ≥4000 MPa/(Ohm·cm²).

In another embodiment, the composite electrolyte membrane has a burst pressure of at least 517 kPa (75 psi) or preferably at least 689 kPa (100 psi) or more preferably at least 758 kPa (110 psi) or even more preferably at least 862 kPa (125 psi).

In another embodiment, the composite electrolyte membrane may further comprise at least one removable support layer attached to one or more external surfaces of the composite electrolyte membrane, such as one or both first and second opposing external surfaces of the composite electrolyte membrane.

In a second aspect, there is provided a membrane electrode assembly for an electrochemical device, comprising:
at least one electrode comprising a first electrode; and
the composite electrolyte membrane according to the first aspect adjacent to the at least one electrode such that the first porous layer is between the first electrode and the at least one reinforced polymer electrolyte membrane.

In one embodiment, the at least one electrode comprises a second electrode; and the second porous layer is between the second electrode and the reinforced polymer electrolyte membrane.

In another embodiment the composite electrolyte membrane is attached to the at least one electrode. In another embodiment, the composite electrolyte membrane is pressed to the at least one electrode.

In another embodiment, the at least one electrode comprises a fiber or fibrous material. The fiber or fibrous material may be electronically conductive. For instance, the at least one electrode may comprise carbon fibers or doped carbon fibers. The carbon fibers or doped carbon fibers may have a diameter from about 8 μm to about 30 μm. Preferably, the doped carbon fibers include N, P, S, or B, and mixtures thereof.

In another embodiment, the at least one electrode is selected from a felt, a paper, mat or a woven material. The a felt, a paper, mat or a woven material may be electronically conductive.

In another embodiment, the at least one electrode comprises an electrode catalyst layer comprising at least one electrode catalyst. Preferably, the at least one electrode catalyst is supported on carbon particles. Typically, the electrode catalyst layer comprises the at least one electrode catalyst on a support and ion exchange material. Preferably, the at least one electrode catalyst comprises one or more of Pt, Ir, Ni, Co, Pd, Ti, Sn, Ta, Nb, Sb, Pb, Mn, Ru and Fe, their oxides, and mixtures thereof. The electrode catalyst layer may be electronically conductive. In some embodiments, the first electrode comprises the electrode catalyst layer comprising the at least one electrode catalyst.

In another embodiment, the electrode catalyst layer has a first surface and an opposing second surface, such that the first surface of the first porous layer is in contact with the first surface of the reinforced polymer electrolyte membrane and the second surface of the first porous layer is in contact with the first surface of the electrode catalyst layer.

In an alternative embodiment, the first electrode has a first surface and an opposing second surface, the first surface of the first porous layer is in contact with the first surface of the at least one reinforced polymer electrolyte membrane and the second surface of the first porous layer is in contact with the first surface of the first electrode.

In another embodiment, the first surface of the at least one reinforced polymer electrolyte membrane comprises a layer of ion exchange material comprising a membrane catalyst.

Such membrane electrode assemblies may be an electrolyzer membrane electrode assembly, or a redox flow battery membrane electrode assembly, or a fuel cell membrane electrode assembly.

In another aspect, there is provided a fuel cell comprising the composite electrolyte membrane as described herein, or the fuel cell membrane electrode assembly as described herein.

In another aspect, there is provided a redox flow battery comprising the composite membrane as described herein, or the redox flow battery membrane electrode assembly as described herein.

In another aspect, there is provided an electrolyzer comprising the composite membrane described herein, or the electrolyzer membrane electrode assembly as described herein.

The present disclosure addresses the problems of low piercing resistance of known PEMs, as mentioned above. It was surprisingly found that utilizing a reinforced polymer electrolyte membrane in combination with plurality of porous layers increases piercing resistance whilst retaining a low proton sheet resistance. Surprisingly, this increased reinforcement may be achieved without increasing the amount of ion exchange material employed, and can even be achieved with a reduction in the amount of ion exchange material employed, compared to known PEMs.

Providing PEMs which are highly resistant to piercing decreases the potential for failure due to electrical shorts occurring if the composite membranes are pierced upon cell assembly. It may also increase the lifetime of the devices fabricated with such membranes by decreasing the occurrence of shorts in use. Furthermore, providing membranes that are highly resistant to piercing by other electrochemical device components without increasing the thickness of the PEM component enables the ion conductance of the membranes to remain high and reduces the cost of manufacture, given that thin membranes require a lower content of ionomer having a comparable fraction of reinforcement.

### BRIEF DESCRIPTION OF THE FIGURES

In the Figures, identical reference numerals have been used for the same or equivalent features of the composite electrolyte membranes disclosed herein.

FIG. 1 shows a schematic representation of the cross-section of a composite electrolyte membrane according to an embodiment of the disclosure. The composite electrolyte membrane comprises a reinforced polymer electrolyte membrane and two porous layers, one located on each of the two opposing exterior surface of the reinforced polymer electrolyte membrane. The reinforced polymer electrolyte membrane comprises a microporous polymer structure and an ion exchange material, in which the ion exchange material is at least partially embedded within the microporous polymer structure to render the microporous polymer structure occlusive.

FIG. 2 shows a schematic representation of the cross-section of a composite electrolyte membrane according to an embodiment of the disclosure. The composite electrolyte membrane has a similar construction to the composite electrolyte membrane of FIG. 1 except that a layer of ion exchange material is present on each of the two opposing surfaces of the microporous polymer structure.

FIG. 3 shows a schematic representation of the cross-section of a composite electrolyte membrane according to another embodiment. The composite membrane has a similar construction to the composite electrolyte membrane of FIG. 2 except that a further layer of ion exchange material is present on one of the layers of ion exchange material on one of the two opposing surfaces of the microporous polymer structure.

FIG. 4 shows a schematic representation of the cross-section of a composite electrolyte membrane according to an embodiment of the disclosure. The composite electrolyte membrane has a similar construction to the composite electrolyte membrane of FIG. 1 except that a layer of ion exchange material is present on each of the two opposing surfaces of the microporous polymer structure and one of these layers of ion exchange materials further comprises at least one catalyst.

FIG. 5 shows a schematic representation of a cross-section of a composite electrolyte membrane according to another embodiment. The composite electrolyte membrane has a similar construction to the composite electrolyte membrane of FIG. 2 except that a layer of ion exchange material comprising at least one catalyst is present on one of the layers of ion exchange material on one of the two opposing surfaces of the microporous polymer structure.

FIG. 6 shows a schematic representation of a cross-section of a membrane electrode assembly comprising first and second electrode layers and a composite electrolyte membrane according to another embodiment. The composite electrolyte membrane has a similar construction to the composite electrolyte membrane of FIG. 2.

FIG. 7 shows a bar chart comparing the average shorting (puncture) pressure of composite electrolyte membranes having a scrim as the porous layers as disclosed herein compared to reinforced and unreinforced polymer electrolyte membranes without a porous layer.

FIG. 8 shows a bar chart comparing the burst pressure of composite electrolyte membranes having a scrim as the porous layers as disclosed herein compared to reinforced and unreinforced polymer electrolyte membranes without a porous layer.

### DETAILED DESCRIPTION

As used herein, the term “integral structure” when used in relation to the composite electrolyte membrane or any other construct means that unless stated otherwise, the individual components of the composite electrolyte membrane or other construct cannot be separated without any damage or irreversible deformation occurring to any of the individual components.

As used herein, ion exchange material may be partly or fully embedded within the microporous polymer structure.

As used herein, a portion of the microporous polymer structure is referred to as rendered “occlusive” or “occluded” when the interior volume of that portion has structures that are characterized by low volume of voids, such as less than 10% by volume, and is highly impermeable to gas, as indicated by Gurley numbers larger than 10000 s. Conversely, the interior volume of a portion of the microporous polymer structure is referred to as “non-occlusive” or “non-occluded” when the interior volume of that portion has structures that are characterized by large volume of voids, for instance more than or equal to 10% by volume, and is permeable to gas, as indicated by Gurley numbers less than or equal to 10000 s.

A portion of, or all of the microporous polymer structure may by rendered occlusive by embedded ion exchange material. If only a portion of the microporous polymer structure is occlusive, it is preferred that this portion is a layer of the microporous polymer structure, such as a layer adjacent to or at an exterior surface of the microporous polymer structure.

As used herein, the term “adjacent” is intended to mean two neighboring elements, such as a microporous polymer structure, porous layer or layer of ion exchange material, which do not have an element of the same type(s) between them, for instance when viewed along an axis perpendicular to the planes of the layers. Thus, a pair of adjacent microporous polymer material layers are two neighboring layers of microporous polymer material which do not have an intervening layer of microporous polymer material between them. However, such adjacent elements of the same type may be separated by one of more elements of a different type. For instance, a pair of adjacent microporous polymer material layers may be separated by one or more layers of ion exchange material and/or one or more porous layers.

Disclosed herein are composite electrolyte membranes for electrochemical devices, such as fuel cells, electrolyzers and redox flow batteries, which exhibit improved shorting pressure and/or burst pressure compared to known composite membranes. Such improved shorting pressure and/or burst pressure is thought to be a result of an improved puncture resistance of the composite membrane to other components of the electrochemical device upon device assembly. Without wishing to be bound by theory, providing a composite electrolyte membrane with a plurality of porous layers having a plurality of pores each having a pore size in the range of from 5 micrometers to 5000 micrometers, placed on opposing sides of at least one reinforced polymer electrolyte membrane, contributes significantly to the improvement in puncture resistance of the composite electrolyte membrane compared to unreinforced polymer electrolyte membranes, reinforced polymer electrolyte membranes or a combination of an unreinforced polymer electrolyte membrane and a porous layer.

In addition, the combination of a reinforced polymer electrolyte and porous layers provides an unexpected synergistic improvement in shortening pressure and burst pressure compared to unreinforced polymer electrolyte membranes, reinforced polymer electrolyte membranes or a combination of an unreinforced polymer electrolyte membrane and a porous layer.

In addition, when the at least two porous layers are present on opposing exterior surfaces of the reinforced polymer electrolyte membrane, increasing the total content of microporous polymer structure of the at least one reinforced polymer electrolyte membrane further improves the piercing resistance of the composite electrolyte membrane. Without wishing to be bound by theory, providing a separation of the microporous polymer structure between at least two reinforcing polymer layers within the composite electrolyte membrane for any given microporous polymer content and thickness of composite electrolyte membrane may further improve the piercing resistance of the composite membrane.

In some embodiments there is provided a composite electrolyte membrane for an electrochemical device, comprising:
a) at least one reinforced polymer electrolyte membrane having a first surface and an opposing second surface, said at least one reinforced polymer electrolyte membrane comprising:
a microporous polymer structure and an ion exchange material, in which the ion exchange material is at least partially embedded within the microporous polymer structure to render the microporous polymer structure occlusive; and
b) a plurality of porous layers comprising a first porous layer and a second porous layer,
the first porous layer having a first surface and an opposing second surface such that the first surface of the first porous layer is adjacent to the first surface of the at least one reinforced polymer electrolyte membrane, wherein the first porous layer has a plurality of pores having a pore size in the range of from 5 micrometers to 5000 micrometers, and the plurality of pores provide one or more passages extending between the first and second surfaces of the first porous layer.

Embodiments are described using volume-based values in order to provide a way for meaningful comparison between the composition of reinforced polymer electrolyte membranes comprising ion exchange materials and microporous polymer structures of different densities.

In order to provide meaningful values of the content of microporous polymer structure within a reinforced polymer electrolyte membrane, whilst also providing these values independently from the intrinsic molecular weight/matrix skeletal density of the microporous polymer structures, embodiments have been described using normalized total mass per area values. This takes into account that some embodiments may comprise different microporous polymer structures within the reinforced polymer electrolyte membrane layers. The content of the of microporous polymer structure within a reinforced polymer electrolyte membrane may also been presented in mass per area values, which is a suitable measurement in embodiments comprising a single type of microporous polymer structure.

The microporous polymer structure may be present in an amount of at least about 20 vol % based on the total volume of the composite polymer electrolyte membrane.

Various definitions used in the present disclosure are provided below.

As used herein, the terms “ion exchange material” and “ionomer” refer to a cation exchange material, an anion exchange material, or an ion exchange material containing both cation and anion exchange capabilities. Mixtures of ion exchange materials may also be employed. Ion exchange material may be perfluorinated or hydrocarbon-based. Suitable ion exchange materials include, for example, perfluorosulfonic acid polymers, perfluorocarboxylic acid polymers, perfluorophosphonic acid polymers, styrenic ion exchange polymers, fluorostyrenic ion exchange polymers, polyarylether ketone ion exchange polymers, polysulfone ion exchange polymers, bis(fluoroalkylsulfonyl)imides, (fluoroalkylsulfonyl) (fluorosulfonyl)imides, polyvinyl alcohol, polyethylene oxides, divinyl benzene, metal salts with or without a polymer, and mixtures thereof. In exemplary embodiments, the ion exchange material comprises perfluorosulfonic acid (PFSA) polymers made by copolymerization of tetrafluoroethylene and perfluorosulfonyl vinyl ester with conversion into proton form.

As used herein, the “equivalent weight” of an ion exchange material or ionomer refers to the weight of polymer (in molecular mass) in the ion exchange material or ionomer per sulfonic acid group. Thus, a lower equivalent weight indicates a greater acid content. The equivalent weight (EW) of the ion exchange material or ionomer refers to the EW if that ion exchange material or ionomer were in its proton form at 0% RH (relative humidity) with negligible impurities. The term “ion exchange capacity” refers to the inverse of equivalent weight (1/EW).

As used herein, the “equivalent volume” of an ion exchange material or ionomer refers to the volume of the ion exchange material or ionomer per sulfonic acid group. The equivalent volume (EV) of the ion exchange material or ionomer refers to the EVif that ionomer were pure and in its proton form at 0% RH, with negligible impurities.

As used herein, the term “microporous polymer structure” refers to a polymeric matrix into which the ion exchange material or ionomer is embedded to support the ion exchange material or ionomer, adding structural integrity and durability to the resulting reinforced polymer electrolyte membrane. In some exemplary embodiments, the microporous polymer structure comprises expanded polytetrafluoroethylene (ePTFE) having a node and fibril structure. In other exemplary embodiments, the microporous polymer structure comprises track etched polycarbonate membranes having smooth flat surfaces, high apparent density, and well defined pore sizes.

### Composite Membranes

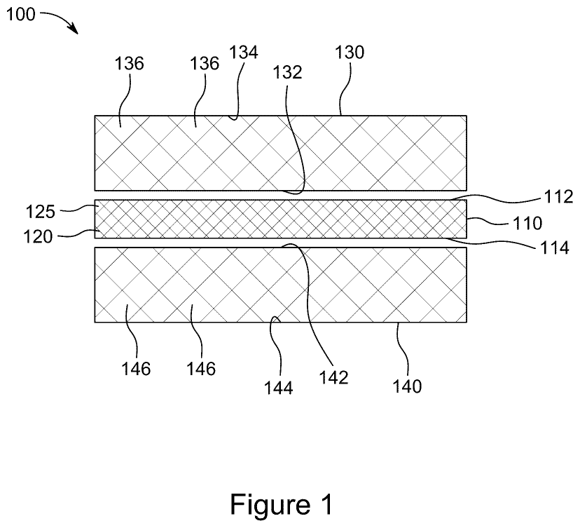

As illustrated in FIGS. 1-5, the composite electrolyte membrane may include at least one reinforced polymer electrolyte membrane and a plurality of porous layers. As shown in these Figures, a composite electrolyte membrane 100 is provided that includes reinforced polymer electrolyte membranes 110 each comprising a microporous polymer structure 120 and an ion exchange material 125 (e.g. ionomer) embedded in the microporous polymer structure of the reinforced polymer electrolyte membranes. That is, each of the microporous polymer structures 120 of the reinforced polymer electrolyte membranes 110 is at least partially imbibed with the ion exchange material 125. The ion exchange material 125 may substantially impregnate the microporous polymer structure of the microporous polymer structures 120 so as to render the interior volume thereof substantially occlusive (i.e. the interior volume having structures that are characterized by low volume of voids and being highly impermeable to gases). For example, by filling greater than 90% of the interior volume of the microporous polymer structure 120 of the reinforced polymer electrolyte membrane 110 with the ion exchange material 125 substantial occlusion will occur, and the membrane will be characterized by Gurley numbers larger than 10000 s. The ion exchange material 125 may be securely adhered to internal surfaces of the microporous polymer structure 120 of the reinforced polymer electrolyte membranes 110 e.g., the fibrils and/or nodes of the microporous polymer structure.

In the embodiment of FIG. 1, opposing first and second surfaces of the microporous polymer structure 120 provide opposing first and second surfaces 112, 114 of the reinforced polymer electrolyte membrane 110.

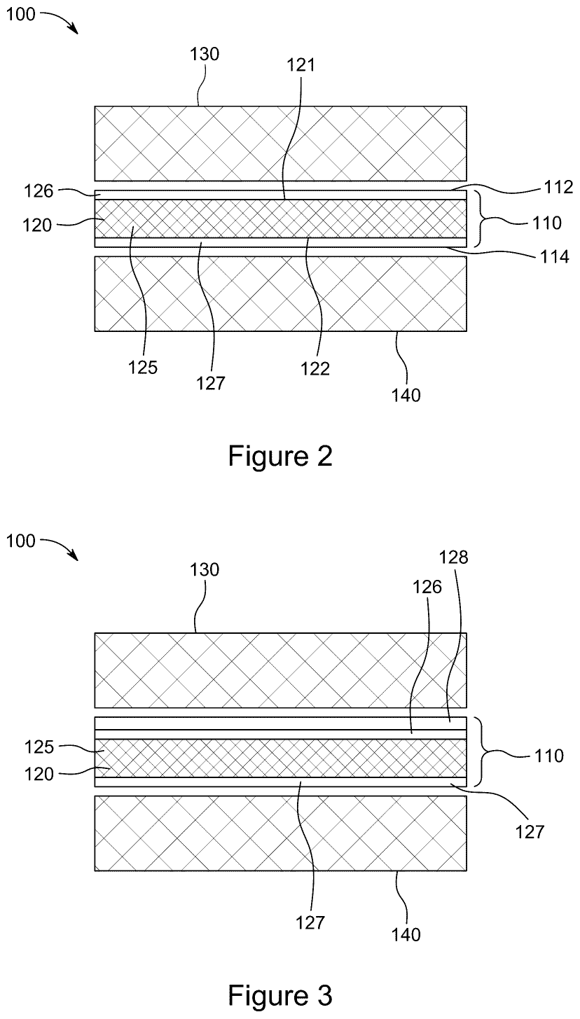

In some embodiments shown in FIGS. 2-5, the ion exchange material, in addition to being embedded in the microporous polymer structures 120 of the reinforced polymer electrolyte membranes 110 is provided as one or more additional layers 126, 127, 128 (e.g., referred also as “butter coat (BC)”) on one or both opposing external surfaces of the microporous polymer structure. The portion of the ion exchange material embedded in the microporous polymer structure provides an anchoring effect on the one or more additional layers of ion exchange material.

In other embodiments, the ion exchange material is provided only on one of the external surfaces of the microporous polymer structure, but not the other surface (not shown).

In other embodiments, the ion exchange material is only provided embedded in the microporous polymer structure 120, i.e., without any additional layers of ion exchange material, such as without any additional butter coats, (FIG. 1). Nonetheless, the composite electrolyte membrane 100 may be characterized by the microporous polymer structure occupying greater than 20% of the total volume of the composite electrolyte membrane 100 which total volume includes the volume of any additional layers 126, 127, 128, if present.

In embodiments according to FIG. 1, a first reinforced polymer electrolyte membrane 110 may be formed by embedding ion exchange material 125 within a first microporous polymer structure 120. For example, ion exchange material may be imbibed into a first side of the first microporous polymer structure 120 to form the first reinforced polymer electrolyte membrane 110. In these embodiments, only a single reinforced polymerelectrolyte membrane 110 is present.

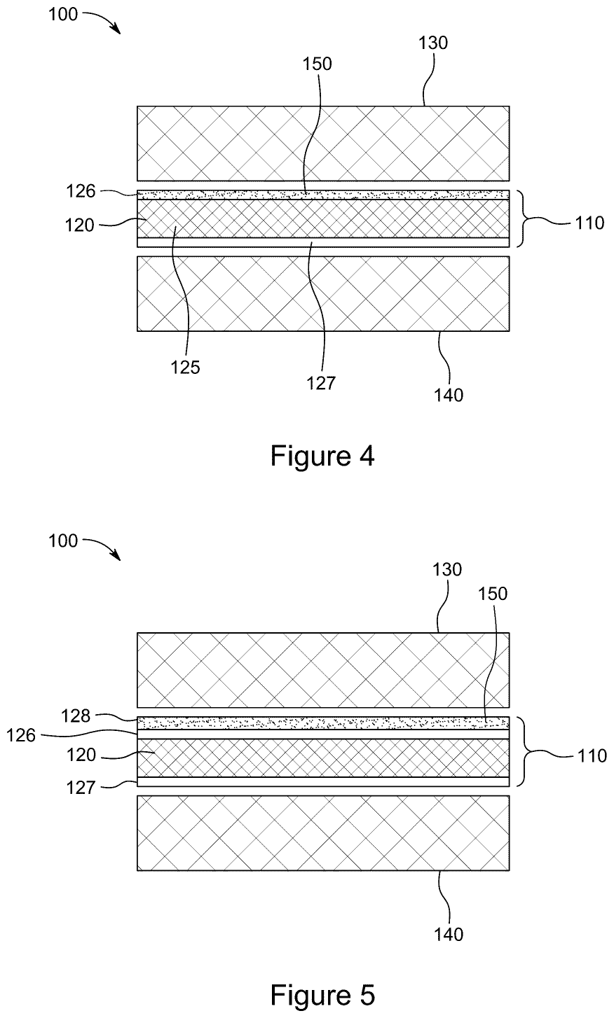

In the embodiments according to FIGS. 2-5, ion exchange material is embedded within a first microporous polymer structure 120 in a similar manner to FIG. 1. However, in the embodiments of FIGS. 2-5, the reinforced polymer electrolyte membranes 110 have two butter coats of ion exchange material 126, 127 disposed on the first and second external surfaces of the of microporous polymer structures 120. The butter coats, i.e. first and second layers of ion exchange material, 126, 127 may comprise the same ion exchange material as that embedded into the microporous polymer structures 120. Alternatively, the ion exchange material of one or both butter coats 126, 127 may be different to that embedded within the microporous polymer structures 120. The ion exchange material of the two butter coats 126, 127 may be the same or different. In the embodiments of FIGS. 2 and 4, the first and second layers of ion exchange material 126, 127 form opposing first and second surfaces 112, 114 respectively of the reinforced polymer electrolyte membrane 110.

In the embodiments of FIGS. 1-5, a plurality of porous layers comprising a first porous layer 130 and second porous layer 140 are provided, with the first and second porous layers being located on opposing first and second exterior surfaces of the reinforced polymer electrolyte membrane 110 respectively. The first and second porous layers 130, 140 may adhere to the at least one reinforced polymer electrolyte membrane 110 due the presence of ionomer in the pores of the first and second surfaces of the microporous polymer structure 120, or due to the presence of ionomer in the layers of ion exchange material 126, 127 (FIGS. 2-5).

Thus, a first porous layer 130 is provided on a first surface of the reinforced polymer electrolyte membrane 110. A second porous layer 140 is provided on a second surface of the reinforced polymer electrolyte membrane 110, the second surface of the reinforced polymer electrolyte membrane opposite to that of the first surface. In these embodiments, the first porous layer 130 and the second porous layer 140 may be a woven material, such as a woven material comprising weft fibers and warp fibers. A leno weave is one such preferred example of a woven material. The fibers forming the woven material may comprise a hydrocarbon polymer such as polyethylene, polypropylene, polycarbonate, polystyrene, or mixtures thereof; or a fluorinated polymer, such as polytetrafluoroethylene (PTFE), poly(ethylene-co-tetrafluoroethylene) (EPTFE), polyvinylidene fluoride (PVDF) or mixtures thereof. The woven material of the first and second porous layers 130, 140 may be the same or different.

In the embodiments of FIGS. 2-5, the reinforced polymer electrolyte membrane 110 comprises first and second layers of ion exchange material 126, 127 on opposing first and second surfaces of the microporous polymer structure 120. It is preferred that the first and second porous layers 130, 140 are partially embedded in the first and second layers of ion exchange material 126, 127 respectively. The partial embedding of the first and second porous layers 130, 140 into the unreinforced layers of ion exchange material 126, 127 can attach the first and second porous layers 130, 140 to the external surfaces 112, 114 of the reinforced polymer electrolyte membrane 110. This attachment provides the composite electrolyte membrane as an integral structure. This embedding may be achieved by pressing the reinforced polymer electrolyte membrane 110 and the first and/or second porous layers 130, 140 together under pressure. This may be carried out under increased temperature to soften the unreinforced layer of ion exchange material and/or when the unreinforced layer of ion exchange material is forming.

Whilst not shown in a figure, in a further embodiment the composite electrolyte membrane of FIG. 1 could be provided with a layer of ion exchange material between the first microporous polymer structure and the first porous layer. Thus, the reinforced polymer electrolyte membrane comprises the microporous polymer structure in which the ion exchange material is partially embedded and a layer of ion exchange material is provided on the microporous polymer structure forming a first surface of the reinforced polymer electrolyte membrane. The first porous layer is on this first surface of the reinforced polymer electrolyte membrane. A portion of the first porous layer may be embedded in the unreinforced layer of ion exchange material. In this way, an integral structure is formed comprising the one reinforced polymer electrolyte membrane and the first porous layer.

Although not shown, in embodiments according to any one of the constructions shown in the figures, the composite electrolyte membrane may be provided on a support layer. The support layer may include a backer layer and a release layer. The backer layer may be a polyester layer, such as polyethylene terephthalate. The release layer may be a cycloolefin copolymer (COC) layer. In some embodiments, the composite electrolyte membrane may be released (or otherwise uncoupled) from the support layer prior to being incorporated in a membrane electrode assembly (MEA).

In embodiments according to FIGS. 2-5, one or more additional layers 126, 127 of the ion exchange material may be provided on one or both opposed external surfaces of the first microporous polymer structure 120. In preferred embodiments, the one or more additional layers of ion exchange material may comprise two or more layers, such as two layers of unreinforced ion exchange material, a first layer 126 disposed on a first external surface the first microporous polymer structure and a second layer 127 disposed on a second external surface of the first microporous polymer structure (i.e. butter coats). The ion exchange material of the additional ion exchange material layers (i.e. butter coats) 126, 127, 128 may be the same or different, and it may be the same or different to the ion exchange material embedded within the first microporous polymer structure.

In embodiment according to FIGS. 2-5, a first ion exchange material may be at least partially embedded in microporous polymer structure 120 of the first reinforced polymer electrolyte membrane 110 by imbibing the first ion exchange material into a first external surface of the microporous polymer structure. In these embodiments, the first reinforced polymer electrolyte membrane 110 has first and second layers 126, 127 of ion exchange material disposed on each of the first and second opposing external surfaces of the microporous polymer structure 120. These two layers of ion exchange materials may comprise second and third ion exchange materials respectively. The layers of ion exchange material may comprise the same ion exchange material as the first ion exchange material, such that the first, second and third ion exchange materials are the same or may be different from the first ion exchange material, such that the second and third ion exchange materials are different from the first ion exchange materials. Furthermore, the second and third ion exchange materials forming the unreinforced ion exchange layers may be the same or different. In addition, the first and second layers of ion exchange materials 126, 127 may have the same or different thicknesses.

In some embodiments, the reinforced polymer electrolyte membrane may have two external layers of ion exchange material on one or both of the opposing external surfaces of the microporous polymer structure. For instance, a further layer of ion exchange material 128 may comprise a membrane catalyst 150 thereby forming a catalyst layer as shown in FIG. 5. In an alternative embodiment, a catalyst may be present in one or both of the first and second layers of ion exchange material. The embodiment of FIG. 4 shows a membrane catalyst 150 present in the first ion exchange layer 126, thereby forming a catalyst layer. These embodiments are discussed in more detail below in relation to the membrane electrode assembly.

Although not specifically shown, other embodiments of composite membranes as described herein may comprise two or more reinforced polymer electrolyte membranes each comprising a microporous polymer structure and an ion exchange material at least partially embedded within the microporous polymer material. In some embodiments, the two or more reinforced polymer electrolyte membranes may have only one external layer of ion exchange material on one of the external surfaces of an outermost microporous polymer structure. In some embodiments, the two or more reinforced polymer electrolyte membranes may have only one external layer of ion exchange material on one of the external surfaces of an outermost microporous polymer structure and also one or more internal layers of ion exchange material between a pair of adjacent microporous polymer material layers.

In some embodiments, the two or more reinforced polymer electrolyte membranes may have two external layers of ion exchange material on the opposing external surface of each outermost microporous polymer structure. In some embodiments, the two or more reinforced polymer electrolyte membranes may have two external layers of ion exchange material on the opposing external surface of each outermost microporous polymer structure and also one or more internal layers of ion exchange material between adjacent microporous polymer material layers.

In some embodiments, the two or more reinforced polymer electrolyte membranes may have an internal layer or layers i.e. butter coats of ion exchange material between each of the microporous polymer material layers. The two or more reinforced polymer electrolyte membranes may have and no layers of ion exchange material on the external surfaces of the two outermost microporous polymer structures.

Each reinforced polymer electrolyte membrane of the composite polymer electrolyte may comprise two (or more) microporous polymer structures, which may be the same or different. In a particular reinforced polymer electrolyte membrane comprising two or more microporous polymer structures, one or more internal butter coats may be situated between adjacent microporous polymer structure layers. Such reinforced polymer electrolyte membrane may have one external layers of ion exchange material on one external surface of an outermost microporous polymer structure or an external layer of ion exchange material on the external surface of both outermost microporous polymer structures.

In embodiments having at least two microporous polymer structures, the two microporous polymer structures may be different. The principle of employing different types of microporous polymer structures in the composite membrane architecture may be applied to any of the embodiments described herein. For example, a first reinforced polymer electrolyte membrane may be formed by at least partially embedding a first ion exchange material within a first microporous polymer structure, and a second reinforced polymer electrolyte membrane may be formed by at least partially embedding a second ion exchange material within a second microporous polymer structure. In these embodiments, the first reinforced polymer electrolyte membrane layer and the second reinforced polymer electrolyte membrane are different. Therefore, in the composite membranes described herein, the first microporous polymer structure may be the same as or different from a second microporous polymer structure. The first ion exchange material may be the same as or different from a second ion exchange material.

In additional embodiments, part of the microporous polymer structure 120 of the reinforced polymer electrolyte membranes 110 (e.g. one or both areas near the opposing exterior surfaces of the microporous polymer structure) may include a non-occlusive portion (i.e. the interior volume having structures that are characterized by high volume of voids and being highly permeable to gases), such as a non-occlusive layer of the microporous polymer structure that is free or substantially free of the ion exchange material. The location of the non-occlusive portion or layer is not limited to areas near the opposing exterior surfaces of the microporous polymer structure. As provided above, the non-occlusive layer may be provided on a portion of the microporous polymer structure of any or all of the reinforced polymer electrolyte membranes.

In yet other embodiments, the non-occlusive portion may include a small amount of the ion exchange material present in an internal surface of the microporous polymer structure as a thin node and fibril coating. However, the amount of the ion exchange material may be not be large enough to render the microporous polymer structure occlusive, thereby forming the non-occlusive portion.

In an embodiment comprising first and second microporous polymer structures, which may be in direct contact with each other, the first microporous polymer structure may be fully imbibed with ion exchange material forming an occlusive layer. However, the second microporous polymer structure is mostly imbibed with the ion exchange material, but comprises a portion or layer which is un-imbibed with ion exchange material or non-occlusive. This non-occlusive portion may be a layer of the second microporous polymer structure closest to an external surface of the reinforced polymer electrolyte membrane. Within the context of this disclosure, mostly imbibed may mean that the microporous polymer structure is about 90% occluded with ion exchange material. In other similar embodiments (not shown), the first microporous polymer structure may comprise a portion or layer which is un-imbibed with ion exchange material or non-occlusive, whilst the second microporous polymer structure may be fully imbibed with ion exchange material forming an occlusive layer. The non-occlusive portion or layer of the first microporous polymer structure may be close to an external surface of the reinforced polymer electrolyte membrane.

In yet other embodiments (not shown), the first and a second microporous polymer structures may both comprise a portion or layer un-imbibed with ion exchange material or a non-occlusive. The non-occlusive portions or layers may be located near one of the external surfaces the reinforcing layer(s). The partially imbibed microporous polymer structures may be about 90% occluded with the ion exchange material.

In embodiments in which there is no internal butter coat between two adjacent microporous polymer structures, the two adjacent microporous polymer structures may be in direct contact (i.e. the two adjacent microporous polymer structures may be separated by a distance d of about 0 μm).

In embodiments in which the composite membrane comprises one or more internal layers of ion exchange material between at two adjacent microporous polymer structures, the two microporous polymer structures may be separated by a distance d. The distance d may be from about 1 μm to about 10 μm. The distance d may be from about 2 μm to about 8 μm. The distance d may be from about 4 μm to about 6 μm. The distance d may be from about 1 μm to about 5 μm. The distance d may be from about 5 μm to about 10 μm. The distance d may be from about 6 μm to about 8 μm. The distance d may be about 1 μm, or about 2 μm, or about 3 μm, or about 4 μm, or about 5 μm, or about 6 μm, or about 7 μm, or about 8 μm, or about 9 μm, or about 10 μm. The distance d may be the thickness of the layer of unreinforced ion exchange material disposed between two adjacent microporous polymer structures (i.e. internal butter coat).

### Microporous Polymer Structure

The composite electrolyte membrane may comprise at least one reinforced polymer electrolyte membrane comprising a microporous polymer structure. For example, the composite electrolyte membrane may comprise 1, 2, 3, 4, 5, 6 7, 8, 9 or 10 reinforced polymer electrolyte membranes, each membrane comprising a microporous polymer structure.

In one embodiment where there are at least two reinforced polymer electrolyte membranes, each of the membranes may be continuous. In another embodiment where there are at least two reinforced polymer electrolyte membranes, each of the at least two membranes may be discontinuous.

A suitable microporous polymer structure depends largely on the application in which the composite electrolyte membrane is to be used. The microporous polymer structure preferably has good mechanical properties, is chemically and thermally stable in the environment in which the composite membrane is to be used, and is tolerant of any additives used with the ion exchange material for impregnation.

As used herein, the term “microporous” refers to a structure having pores that are not visible to the naked eye. According to various optional embodiments, the pores may have an average pore size from 0.01 to 100 microns, e.g., from 0.05 to 20 microns or from 0.1 to 1 microns.

As used herein, the term “microporous polymer structure” is intended to refer to a layer having a thickness at 0% RH, before the ion exchange material has been at least partially embedded within it, of from about 0.5 μm to about 500 μm, or from about 2 μm to about 150 μm or from about 2 μm to about 100 μm, or from about 2 μm to about 70 μm, or from about 2 μm to about 40 μm, or from about 2 μm to about 20 μm, and having an average micropore size from about 0.05 μm to about 20 μm, e.g., from 0.1 μm to 1 μm.

A suitable microporous polymer structure 120 of the reinforced polymer electrolyte membranes 110 for electrochemical applications may comprise a porous polymeric material.

The porous polymeric material may be selected from the group comprising fluoropolymers, chlorinated polymers, hydrocarbons, polyamides, polycarbonates, polyacrylates, polysulfones, copolyether esters, polyethylene, polypropylene, polyvinylidene fluoride, polyaryl ether ketones, polybenzimidazoles, poly(ethylene-co-tetrafluoroethylene), poly(tetrafluoroethylene-co-hexafluoropropylene). In some embodiments, the microporous polymer structure 120 comprises a perfluorinated porous polymeric material. The perfluorinated porous polymeric material may be selected from the group comprising polytetrafluoroethylene (PTFE), expanded polytetrafluoroethylene (ePTFE), polyvinylidene fluoride (PVDF), expanded polyvinylidene fluoride (ePVDF), expanded poly(ethylene-co-tetrafluoroethylene) (eEPTFE) and mixtures thereof.

In some embodiments, the microporous polymer structure comprises a hydrocarbon material. The hydrocarbon material may be selected from the group comprising polyethylene, expanded polyethylene, polypropylene, expanded polypropylene, polystyrene, polycarbonate, track etched polycarbonate and mixtures thereof. Examples of suitable perfluorinated porous polymeric materials for use in fuel cell applications include ePTFE made in accordance with the teachings of U.S. Pat. No. 8,757,395, which is incorporated herein by reference in its entirety, and commercially available in a variety of forms from W. L. Gore & Associates, Inc., of Elkton, MD.

In embodiments in which the microporous polymer structure comprises ePTFE, the total mass per area of the microporous polymer structure may be from about 0.5 g/m² to about 100 g/m² based on the total area of the composite electrolyte membrane or from 0.5 g/m² to about 30 g/m² or from about 0.5 g/m² to about 21 g/m² or from about 0.5 g/m² to about 10 g/m² or from about 0.5 g/m² to about 8 g/m² or from about 0.5 g/m² to about 6 g/m² or from about 2 g/m² to about 30 g/m² or from about 2 g/m² to about 21 g/m² or from about 2 g/m² to about 10 g/m² or from about 2 g/m² to about 8 g/m² or from about 2 g/m² to about 6 g/m² or from about 30 g/m² to about 100 g/m² or from about 30 g/m² to about 80 g/m² or from about 30 g/m² to about 60 g/m². For example, in embodiments in which the microporous polymer structure comprises ePTFE, the total mass per area of the microporous polymer structure may be about 5.5 g/m², or about 5.8 g/m², or about 6 g/m², or about 7 g/m², or about 8 g/m², or about 9 g/m², or about 10 g/m², or about 11 g/m², or about 12 g/m², or about 13 g/m², or about 14 g/m², or about 15 g/m², or about 16 g/m², or about 17 g/m², or about 18 g/m², or about 19 g/m², or about 20 g/m², based on the total area of the composite membrane.

### Ion Exchange Material

A suitable ion exchange material may be dependent on the application in which the composite electrolyte membrane is to be used. The ion exchange material preferably has an average equivalent volume from about 240 cc/mole eq to about 1000 cc/mole eq, optionally from about 240 cc/mole eq to about 650 cc/mole eq, optionally from about 240 cc/mole eq to about 475 cc/mole eq, optionally from about 350 cc/mole eq to about 475 cc/mol eq. The ion exchange material may be is chemically and thermally stable in the environment in which the composite electrolyte membrane is to be used. A suitable ion exchange material for fuel cell applications may include a cation exchange material, an anion exchange material, or an ion exchange material containing both cation and anion exchange capabilities. In some embodiments, the ion exchange material comprises a proton conducting polymer or cation exchange material. The ion exchange material may be selected from the group comprising perfluorocarboxylic acid polymers, perfluorophosphonic acid polymers, styrenic ion exchange polymers, fluorostyrenicion exchange polymers, polyarylether ketone ion exchange polymers, polysulfone ion exchange polymers, bis(fluoroalkylsulfonyl)imides, (fluoroalkylsulfonyl) (fluorosulfonyl)imides, polyvinyl alcohol, polyethylene oxides, divinyl benzene, metal salts with or without a polymer and mixtures thereof. Examples of suitable perfluorosulfonic acid polymers for use in fuel cell applications include Nafion® (E.I. DuPont de Nemours, Inc., Wilmington, Del., US), Flemion® (Asahi Glass Co. Ltd., Tokyo, JP), Aciplex® (Asahi Chemical Co. Ltd., Tokyo, JP), Aquivion® (SolvaySolexis S.P.A, Italy), and 3M™ (3M Innovative Properties Company, USA) which are commercially available perfluorosulfonic acid copolymers. Other examples of suitable perfluorosulfonic acid polymers for use in fuel cell applications include perfluorinated sulfonyl (co) polymers such as those described in U.S. Pat. No. 5,463,005.

A layer of the ion exchange material may have a thickness at 0% RH in the range of from about 0.5 μm to about 20 μm or from about 0.5 μm to about 15 μm or from about 0.5 μm to about 12 μm or from about 0.5 μm to about 8 μm or from about 0.5 μm to about 5 μm or from about 2 μm to about 5 μm

For use in a redox flow battery, the microporous polymer structure in which the ion exchange material has been at least partially embedded to render the microporous polymer structure occlusive may have a thickness at 0% RH in the range of from about 0.5 μm to about 30 μm or from about 0.5 μm to about 21 μm or from about 0.5 μm to about 10 μm or from about 0.5 μm to about 8 μm or from about 0.5 μm to about 6 μm or from about 2 μm to about 30 μm or from about 2 μm to about 21 μm or from about 2 μm to about 10 μm or from about 2 μm to about 8 μm or from about 2 μm to about 6 μm.

For use in an electrolyzer, the microporous polymer structure in which the ion exchange material has been at least partially embedded to render the microporous polymer structure occlusive may have a thickness at 0% RH in the range of from about 30 μm to about 100 μm or from about 30 μm to about 250 μm or from about 30 μm to about 500 μm.

The reinforced polymer electrolyte membrane may have a thickness at 0% RH in the range of from about 2 micrometer to 500 micrometers.

### Membrane Catalyst

In some embodiments, one or more of the at least one layer of ion exchange material, such as first layer 126, second layer 127 or the at least one further layer of ion exchange material, such as third layer 128 of ion exchange material, may further comprise at least one membrane catalyst 150.

FIG. 4 shows an embodiment in which the first layer of ion exchange material 126 comprises a membrane catalyst 150. FIG. 5 shows an embodiment in which a further layer of ion exchange material 128, present on the first layer of ion exchange material 126, comprises a membrane catalyst 150. The further layer of ion exchange material 128 may be a third layer of ion exchange material. Alternatively or additionally, the second layer of ion exchange material 127 may comprise a membrane catalyst (not shown in the Figures).

The at least one membrane catalyst may comprise a first membrane catalyst 150 comprising one or more of Pt, Ir, Ni, Co, Pd, Ti, Sn, Ta, Nb, Sb, Pb, Mn, Ru and Fe and mixtures thereof. The at least one membrane catalyst may be present on a support, for instance a particulate support, such as a carbon particulate.

### Reinforced Polymer Electrolyte Membrane

The reinforced polymer electrolyte membrane comprises the microporous polymer structure and an ion exchange material, in which the ion exchange material is at least partially embedded within the microporous polymer structure to render the microporous polymer structure occlusive. The reinforced polymer electrolyte structure may also comprise one or more layers of ion exchange material. A membrane catalyst may be present with the ion exchange material

The reinforced polymer electrolyte membrane may have a thickness at 0% RH in the range of from 2 micrometers to 500 micrometers. For instance, the reinforced polymer electrolyte membrane may have a thickness in the range of from 4 micrometer to 30 micrometer. Alternatively, the may have a thickness at 0% RH of from about 15 μm to about 500 μm, or from about 15 μm to about 250 μm, or from about 15 μm to about 200 μm, or from about 15 μm to about 150 μm, or from about 15 μm to about 100 μm, or from about 15 μm to about 50 μm, or from about 30 μm to about 500 μm, or from about 30 μm to about 250 μm, or from about 30 μm to about 150 μm, or from about 30 μm to about 100 μm, or from about 30 μm to about 50 μm, or from about 50 μm to about 500 μm, or from about 50 μm to about 250 μm, or from about 50 μm to about 200 μm, or from about 50 μm to about 150 μm, or from about 50 μm to about 100 μm.

### Porous Layers

A suitable porous layer may be dependent on the application in which the composite electrolyte membrane is to be used. The porous layers should have a plurality of pores having a pore size in the range of from 5 micrometers to 5000 micrometers. The plurality of pores provide one or more passages extending between a first surface, such as an first external surface and an opposing second surface, such as a second external surface opposite to that of the first surface, of a porous layer. One of the first and second external surfaces of the first and second porous layers is adjacent to the reinforced polymer electrolyte membrane. The pores represent continuous channels which extend between the external surfaces of the porous layer such that ions may be conducted from one surface of the porous layer, along the pores, to another surface of the porous layer, thereby providing an ionic conduction path from an exterior surface of the first porous layer, through the first porous layer, the reinforced polymer electrolyte membrane, and the second porous layer, to an exterior surface of the second porous layer or vice versa.

The porous layers may be independently selected from woven material, non-woven material or a combination thereof. The woven or non-woven materials may comprise fiber or fibrous material. A preferred woven material is a leno weave. Alternatively, the plurality of porous layers may be a non-woven material such as a mesh, a knitted material, paper, felt, mat or cloth. Combinations of a woven material and a non-woven material are also within the scope of this disclosure.

In some embodiments, the fibers may have aspect ratios of the length to width and length to thickness both of which are greater than about 10 and a width to thickness aspect ratio of less than about 5. Both the length to thickness and length to width aspect ratios of the fibre may be between about 10 and about 1000000, between 10 and about 100000, between 10 and about 1000, between 10 and about 500, between 10 and about 250, between 10 and about 100, between about 10 and about 50, between about 20 and about 1000000, between 20 and about 100000, between 20 and about 1000, between 20 and about 500, between 20 and about 250. between 20 and about 100 or even between about 20 and about 50.

Non-woven materials for the plurality of porous layers may be fabricated by processes known in the art, such as melt blown fibers, spunbonding, carding and the like.

In some embodiments, the fiber or fibrous material forming the woven material or non-woven material of the plurality of porous layers may be a thermoplastic polymer. Such fiber or fibrous material may be selected from the group comprising epoxy resin, phenolic resin. polyurethanes. urea-formaldehyde resin, melamine resin. polyesters, e.g. polyethylene terephthalate, polyamides, polyethers. polycarbonates, polyimides. polysulphones, polyphenylene oxides, polyacrylates, polymethacrylates, polyolefin, e.g. polyethylene and polypropylene, styrene and styrene based random and block copolymers, e g. styrene-butadiene-styrene, polyvinyl chloride, and fluorinated polymers, e g polyvinylidene fluoride and polytetrafluoroethylene.

In some embodiments, the fibre or fibrous material comprises at least one of polyurethanes, polyesters, polyamides. polyethers, polycarbonates, polyimides, polysulphones, polyphenylene oxides. polyacrylates. polymethacrylates, polyolefin, styrene and styrene based random and block copolymers, polyvinyl chloride. and fluorinated polymers.

In a preferred embodiment, the plurality of porous layers comprise at least one fluorinated polymer, such as a fluorinated fiber or fluorinated fibrous material. The fluorinated polymer may be selected from the group comprising polytetrafluoroethylene (PTFE), poly(ethylene-co-tetrafluoroethylene) (EPTFE), polyvinylidene fluoride (PVDF) and mixtures thereof. More preferably, the fluorinated polymer is polytetrafluoroethylene (PTFE).

In an alternative embodiment, the plurality of porous layers comprise a hydrocarbon polymer, such as a hydrocarbon polymer fiber or hydrocarbon polymer fibrous material. The hydrocarbon polymer may be selected from the group comprising polyethylene, polypropylene, polycarbonate, polystyrene, and mixtures thereof.

Each of the plurality of porous layers may have a thickness at 0% RH in the range of from about 15 μm to about 500 μm or from about 15 μm to about 250 μm or from about 15 μm to about 200 μm or from about 15 μm to about 150 μm or from about 15 μm to about 100 μm or from about 15 μm to about 50 μm or from about 30 μm to about 500 μm or from about 30 μm to about 250 μm or from about 30 μm to about 150 μm or from about 30 μm to about 100 μm or from about 30 μm to about 50 μm or from about 50 μm to about 500 μm or from about 50 μm to about 250 μm or from about 50 μm to about 200 μm or from about 50 μm to about 150 μm or from about 50 μm to about 100 μm.

The plurality of porous layers may have an air permeability of greater than 6000 I/hr at a differential pressure of 12 mbar for an open area of 2.99 cm².

In some embodiments, the plurality of porous layers may have an open area porosity in the range of from 0.80 to 0.98, preferably about 0.95.

In some embodiments, the plurality of porous layers may be hydrophilic. A hydrophilic porous layer enhances compatibility with aqueous electrolytes.

### Properties of the Composite Electrolyte Membrane

As discussed above, the composite electrolyte membrane comprises a) at least one reinforced polymer electrolyte membrane comprising a microporous polymer structure and an ion exchange material in which the ion exchange material is at least partially embedded within the microporous polymer and b) a plurality of porous layers thereby forming distinct components which together achieve improved piercing resistance of the composite electrolyte membrane. Without wishing to be bound by theory, the piercing resistance of the composite electrolyte membrane may be influenced by the reinforced polymer electrolyte membrane and porous layer compared to ion exchange material in an unreinforced layer optionally in combination with a porous layer or a reinforced polymer electrolyte membrane and no porous layer.

The composite electrolyte membrane (reinforced polymer electrolyte membrane and porous layers) may have a thickness at 0% RH in the range of from about 15 μm to about 1500 μm. In one embodiment, the plurality of porous layers may have a thickness at 0% RH in the range of from 15 μm to about 500 μm or from about 15 μm to about 250 μm or from about 15 μm to about 200 μm or from about 15 μm to about 150 μm or from about 15 μm to about 100 μm or from about 15 μm to about 50 μm or from about 30 μm to about 500 μm or from about 30 μm to about 250 μm or from about 30 μm to about 150 μm or from about 30 μm to about 100 μm or from about 30 μm to about 50 μm or from about 50 μm to about 500 μm or from about 50 μm to about 250 μm or from about 50 μm to about 200 μm or from about 50 μm to about 150 μm or from about 50 μm to about 100 μm. In another embodiment, the plurality of porous layers may have a thickness at 0% RH in the range of from about 30 μm to about 1500 μm or from about 30 μm to about 1250 μm or from about 30 μm to about 1100 μm or from about 30 μm to about 800 μm or from about 30 μm to about 500 μm or from about 30 μm to about 300 μm or from about 30 μm to about 250 μm or from about 30 μm to about 150 μm or from about 60 μm to about 1500 μm or from about 60 μm to about 1250 μm or from about 60 μm to about 1100 μm or from about 60 μm to about 800 μm or from about 60 μm to about 500 μm or from about 60 μm to about 300 μm or from about 60 μm to about 250 μm or from about 60 μm to about 150 μm or from about 100 μm to about 1500 μm or from about 100 μm to about 1250 μm or from about 100 μm to about 1100 μm or from about 100 μm to about 800 μm or from about 100 μm to about 500 μm or from about 100 μm to about 300 μm or from about 100 μm to about 250 μm or from about 100 μm to about 150 μm.

The composite electrolyte membrane may have a thickness at 0% RH of about 15 μm, or about 16 μm, or about 17 μm, or about 18 μm, or about 19 μm, or about 20 μm, or about 21 μm, or about 22 μm, or about 23 μm, or about 24 μm, or about 25 μm, or about 30 μm, or about 35 μm, or about 40 μm, or about 45 μm, or about 50 μm, or about 55 μm, or about 60 μm, or about 65 μm, or about 70 μm, or about 75 μm. The composite electrolyte membrane may not have a thickness at 0% RH below about 10 μm.

In some embodiments, the microporous polymer structure occupies from about 2 vol % to about 65% based on the total volume of the composite electrolyte membrane, or from about 15 vol % to about 65% or from about 20 vol % to about 65%, or from about 30 vol % to about 65%, or from about 40 vol % to about 65%, or from about 50 vol % to about 65%, or from about 65 vol % to about 65%, or from about 25 vol % to about 60% or from about 20 vol % to about 50%, or from about 20 vol % to about 40%, or from about 20 vol % to about 30%, or from about 40 vol % to about 60%, or from about 40 vol % to about 50% based on the total volume of the composite electrolyte membrane. The microporous polymer structure may be present in an amount of about 15 vol %, or about 20 vol %, or about 25 vol %, or about 30 vol %, or about 35 vol %, or about 40 vol %, or about 45 vol %, or about 50 vol %, or about 55 vol %, or about 60 vol %, or about 65 vol %, based on the total volume of the composite electrolyte membrane.

In some embodiments, the equivalent volume of the ion exchange material is from about 240 cc/mol eq to about 1000 cc/mol eq. The ion exchange material may have a total equivalent weight (EW) from about 240 g/eq to about 2000 g/eq SO₃⁻. In various embodiments, the acid content of the composite electrolyte membrane 100, 200, 300, 400 is greater than 1.2 meq/cc, for example from greater than 1.2 meq/cc to 3.5 meq/cc at 0% relative humidity. In various embodiments, the thickness of the composite electrolyte membrane 100, 200, 300, 400 at 0% RH is from about 4 μm to about 115 μm or from about 4 μm to about 50 μm or from about 4 μm to about 40 μm or from about 4 μm to about 36 μm or from about 4 μm to about 30 μm or from about 4 μm to about 25 μm or from about 4 μm to about 15 μm or from about 4 μm to about 8 μm or from about 10 μm to about 115 μm or from about 10 μm to about 50 μm or from about 10 μm to about 40 μm or from about 10 μm to about 36 μm or from about 10 μm to about 30 μm or from about 10 μm to about 25 μm or from about 10 μm to about 15 μm. Specifically, according to embodiments, the thickness of the composite electrolyte membrane 100, 200, 300, 400 is from about 4 μm to about 115 μm while the acid content of the composite membrane 100, 200, 300, 400 is in the range of from greater than 1.2 meq/cc to 3.5 meq/cc.

The volume % of the microporous polymer structure in the composite material refers to the space occupied by the microporous polymer structure nodes and fibrils, which is free of the ionomer. Accordingly, the volume % of the microporous polymer structure in the composite material is different than the imbibed layer which contains ionomer. The volume % of the microporous polymer structure in the composite material is affected by the humidity. Therefore, the experiments discussed below regarding volume % are conducted at dry conditions (e.g. 0% relative humidity (RH)).

In some embodiments, the normalized total content of the microporous polymer structure within the composite membrane may be at least about 3×10⁻⁶ m, or about 3.5×10⁶ m, or about 4×10⁻⁶ m, or about 4.5×10⁻⁶ m, or about 5×10⁻⁶ m, or about 5.5×10⁻⁶ m, or about 6×10⁻⁶ m, or about 6.5×10⁻⁶ m, or about 7×10⁻⁶ m, or about 8×10⁻⁶ m, or about 8.5×10⁻⁶ m, or about 9×10⁻⁶ m based on the total area of the composite membrane.

The equivalent weight of the ion exchange material is also affected by the humidity. Therefore, the experiments discussed below regarding equivalent weight are conducted at dry conditions (e.g. 0% relative humidity (RH)) at an ideal state were presence of water does not affect the value of equivalent volume and meaningful comparison between different ionomers can be drawn.

As provided above, it is surprising and unexpected that the puncture resistance of the composite electrolyte membrane is dramatically improved by providing a reinforced polymer electrolyte membrane in combination with a porous layers.

The composite electrolyte membrane may have an average burst pressure of at least about 40 psi, when measured by the Average Burst Pressure Test described hereinbelow. For example, the composite electrolyte membrane may have an average burst pressure of at least about 60 psi, or at least about 80 psi, or at least about 100 psi when measured by the Average Burst Pressure Test described hereinbelow. The composite electrolyte membrane may have an average burst pressure of less than about 200 psi, when measured by the Average Burst Pressure Test described hereinbelow.

The composite membrane may have an average shorting pressure of at least about 130 psi, when measured by the Average Shorting Pressure Test described hereinbelow. For example, the composite electrolyte membrane may have an average shorting pressure of from about 140 psi, or from about 200 psi, or from about 300 psi, or from about 350 psi, when measured by the Average Shorting Pressure Test described hereinbelow. The composite membrane may have an average shorting pressure of less than about 800 psi, when measured by the Average Shorting Pressure Test described hereinbelow.

The composite membrane may have an average failure pressure of from about 150 psi, or about 200 psi, or about 250 psi, or about 300 psi, or about 350 psi, or about 400 psi, or about 450 psi, or about 500 psi, when measured by the Average Puncture Pressure Failure Test described hereinbelow.

### Methods of Preparation

The reinforced polymer electrolyte membranes can be prepared following the process described for FIGS. 4A, 4B and 4C of WO 2018/231232 A1, the content of which are incorporated herein in its entirety.

In one embodiment, the at least one reinforced polymer electrolyte membrane may comprise a first reinforced polymer electrolyte membrane formed by a method comprising at least the steps of:
providing a support structure;
applying a first ion exchange material solution as a layer of controlled thickness to the support structure in a single or multiple pass ion exchange material coating technique, in which the first ion exchange material solution comprises a first ion exchange material dissolved in a solvent;
laminating a microporous polymer structure over at least a portion of the first ion exchange material solution to provide a treated microporous polymer structure; and
drying the treated microporous polymer structure to provide the first reinforced polymer electrolyte membrane in which the first ion exchange material is securely adhered to the internal surfaces of the microporous polymer structure.

The ion exchange material is at least partially embedded in the microporous polymer structure to render the microporous polymer structure occlusive. The first reinforced polymer electrolyte membrane may comprise a layer of first ion exchange material on a surface of the microporous polymer structure.

In another embodiment, the at least one reinforced polymer electrolyte membrane may comprise a first reinforced polymer electrolyte membrane formed by a method comprising at least the steps of:
providing a support structure;
applying a first ion exchange material solution as a layer of controlled thickness to the support structure in a single or multiple pass ion exchange coating technique, in which the first ion exchange material solution comprises a first ion exchange material dissolved in a solvent;
laminating a microporous polymer structure over at least a portion of the first ion exchange material solution to provide a treated microporous polymer structure;
optionally drying the treated microporous polymer structure to provide a dried composite material in which the first ion exchange material is securely adhered to the internal surfaces of the microporous polymer structure-coating a second ion exchange material solution over the treated microporous polymer structure or optionally the dried composite material as a layer of controlled thickness in a single or multipass ion exchange material coating technique to provide a structure, in which the second ion exchange material solution comprises a second ion exchange material dissolved in a solvent; and
drying the structure to provide the first reinforced polymer electrolyte membrane.

The first reinforced polymer electrolyte membrane comprises a layer of first ion exchange material on a first surface of the microporous polymer structure and a layer of second ion exchange material on an opposing second surface of the microporous polymer structure.

In some embodiments, the support structure may be:
a woven material selected from scrims made of woven fibers of expanded porous polytetrafluoroethylene, webs made of extruded or oriented polypropylene or polypropylene netting, and woven materials of polypropylene and polyester, or
a non-woven material selected from a spun-bonded polypropylene; or
a web of polyethylene (“PE”), polystyrene (“PS”), cyclic olefin copolymer (“COC”), cyclic olefin polymer (“COP”), fluorinated ethylene propylene (“FEP”), perfluoroalkoxy alkanes (“PFAs”), ethylene tetrafluoroethylene (“ETFE”), polyvinylidene fluoride (“PVDF”), polyetherimide (“PEI”), polysulfone (“PSU”), polyethersulfone (“PES”), polyphenylene oxide (“PPO”), polyphenyl ether (“PPE”), polymethylpentene (“PMP”), polyethyleneterephthalate (“PET”), or polycarbonate (“PC”).

In some embodiments, the support structure further comprises a protective layer selected from polyethylene (PE), polystyrene (“PS”), cyclic olefin copolymer (“COC”), cyclic olefin polymer (“COP”), fluorinated ethylene propylene (“FEP”), perfluoroalkoxy alkanes (“PFAs”), ethylene tetrafluoroethylene (“ETFE”), polyvinylidene fluoride (“PVDF”), polyetherimide (“PEI”), polysulfone (“PSU”), polyethersulfone (“PES”), polyphenylene oxide (“PPO”), polyphenyl ether (“PPE”), polymethylpentene (“PMP”), polyethyleneterephthalate (“PET”), or polycarbonate (“PC”).

In some embodiments, the single or multipass ion exchange material coating technique is selected from forward roll coating, reverse roll coating, gravure coating, doctor coating, kiss coating, slot die coating, slide die coating, dipping, brushing, painting, and spraying. As used herein, a multipass ion exchange material coating technique comprises at least two sequential applications of an ion exchange material solution comprising an ion exchange material dissolved in a solvent.

In some embodiments, the drying comprises heating at a temperature greater than 60° C., for instance in an oven.

In some embodiments, the second ion exchange material is the same as the first ion exchange material. In other embodiments, the second ion exchange material is different than the first ion exchange material.

In another embodiment, the at least one reinforced polymer electrolyte membrane may comprise a first reinforced polymer electrolyte membrane and a second reinforced polymer electrolyte membrane formed by a method comprising at least the steps of:
providing a support structure;
applying a first ion exchange material solution as a layer of controlled thickness to the support structure in a single or multiple pass ion exchange material coating technique, in which the first ion exchange material solution comprises a first ion exchange material dissolved in a solvent;
laminating a first microporous polymer structure over at least a portion of the first ion exchange material solution to provide a first treated microporous polymer structure;
optionally drying the first treated microporous polymer structure to provide a first dried composite material in which the first ion exchange material is securely adhered to the internal membrane surfaces of the first microporous polymer structure;
coating a second ion exchange material solution over the first treated microporous polymer structure or the optionally first dried composite material as a layer of controlled thickness in a single or multipass ion exchange material coating technique, in which the second ion exchange material solution comprises a second ion exchange material dissolved in a solvent;
laminating a second microporous polymer structure over at least a portion of the second ion exchange material solution to provide a second treated microporous polymer structure;
optionally drying the second treated microporous polymer structure to provide a second dried composite material in which the second ion exchange material is securely adhered to the internal membrane surfaces of the second microporous polymer structure;
coating a third ion exchange material solution over the second treated microporous polymer structure or the optionally dried second microporous polymer structure as a layer of controlled thickness in a single or multipass ionomer coating technique to provide a third treated microporous polymer structure, in which the third ion exchange material solution comprises a third ion exchange material dissolved in a solvent; and
drying the third treated microporous polymer structure to provide the first reinforced polymer electrolyte membrane.

The ion exchange materials are at least partially embedded in the microporous polymer structures to render the microporous polymer structures occlusive. The at least one reinforced polymer electrolyte membrane may comprise a first reinforced polymer electrolyte membrane comprising a layer of first ion exchange material on a first surface of the first microporous polymer structure, and a layer of second ion exchange material on an opposing second surface of the first microporous polymer structure and a second reinforced polymer electrolyte membrane comprising the layer of second ion exchange material on a first surface of the second microporous polymer structure and a layer of third ion exchange material on an opposing second surface of the second microporous polymer structure. Thus, the layer of second ion exchange material is present between the first and second microporous polymer structures.

In some embodiments, the first, second and third ion exchange materials may independently be the same or different.

In some embodiments, the definition of the support, the single or multipass coating techniques and the heating step may be as described previously.

In an embodiment, the composite electrolyte membrane may be formed by a method comprising at least the steps of:
providing at least one reinforced polymer electrolyte membrane comprising a first reinforced polymer electrolyte membrane having a first surface and an opposing second surface;
adding a first porous layer having a first surface and an opposing second surface to the first reinforced polymer electrolyte membrane such that the first surface of the first porous layer is adjacent to the first surface of the first reinforced polymer electrolyte membrane; and
adding a second porous layer having a first surface and an opposing second surface to the first reinforced polymer electrolyte membrane such that the first surface of the second porous layer is adjacent to the second surface of the first reinforced polymer electrolyte membrane to provide the composite electrolyte membrane.

In one embodiment, the first reinforced polymer electrolyte membrane can comprise first and second layers of ion exchange material on the opposing first and second surfaces of the microporous polymer structure, such that the adding step comprises partially embedding the first and second porous layers in the first and second layers of ion exchange material. In this way, the first and second porous layers are attached to the first reinforced polymer electrolyte membrane. For instance, the embedding may be achieved by the step of pressing the first reinforced polymer electrolyte membrane and the first and/or second porous layers together under pressure. This may be carried out with heating to soften the first and/or second layers of ion exchange material and/or the pressing may be carried out when the first and/or second layers of ion exchange material are forming.

In another embodiment, the step of providing the at least one reinforced polymer electrolyte membrane comprising a first reinforced polymer electrolyte membrane may be one of the methods of forming the at least one reinforced polymer electrolyte membrane described above.

### Membrane Electrode Assembly

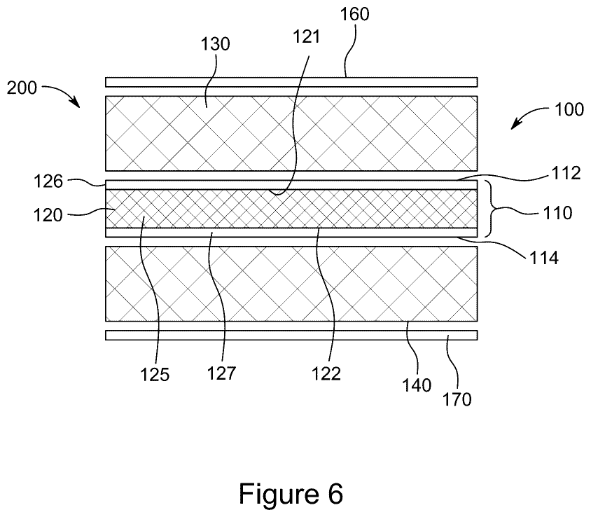

The composite electrolyte membranes disclosed herein may also be incorporated into membrane electrode assemblies. In an embodiment shown in FIG. 6, there is provided a membrane electrode assembly 200 for an electrochemical device, comprising at least one electrode comprising a first electrode 160; and the composite electrolyte membrane described herein. The composite electrolyte membrane is adjacent to the at least one electrode such that the first porous layer 130 is between the first electrode 160 and the at least one reinforced polymer electrolyte membrane 110. In this way, the at least one reinforced polymer electrolyte membrane 110 is protected from damage by the first electrode 160 by the intervening first porous layer 130.

In some embodiments of the membrane electrode assembly 200, the at least one electrode may further comprise a second electrode 170. The second porous layer 140 may be located between the second electrode 170 and the reinforced polymer electrolyte membrane 110. In this way, the at least one reinforced polymer electrolyte membrane 110 is protected from damage by the second electrode 170 by the intervening second porous layer 140.

In some embodiments, the composite electrolyte membrane may be attached to the at least one electrode. For instance, the composite electrolyte membrane and the at least one electrode may be pressed together.

In some embodiments, the at least one electrode may comprise a fiber or fibrous material. Such fibers or fibrous material may be responsible for damage to or penetration of the at least one reinforced polymer electrolyte membrane by the fibers or fibrous material. Examples of fibers or fibrous material forming an electrode include carbon fibers or doped carbon fibers. Suitable carbon fibers or doped carbon fibers may have a diameter of from about 8 to about 30 μm. The doped carbon fibers may comprise N, P, S, or B, and mixtures thereof.

The at least one electrode may be selected from a felt, a paper, mat or a woven material.

The combination of the reinforced polymer electrolyte membrane 110 disposed between first and second porous layers 130, 140 provides improved protection from puncturing of the reinforced polymer electrolyte membrane by fibers from the first and second electrodes 160, 170. This is evidenced by significantly improved burst pressure and shorting pressure of a cell containing such a membrane electrode assembly when compared to unreinforced polymer electrolyte membranes, unreinforced polymer electrolyte membranes in with a porous layer or a reinforced polymer electrolyte membrane without a porous layer.

Such membrane electrode assemblies 200 may be used as membrane electrode assemblies in a redox flow battery.

The at least one electrode may comprise an electrode catalyst layer (not shown) comprising at least one electrode catalyst. The electrode catalyst layer may further comprise an ion exchange material, such as those discussed above. The at least one electrode catalyst may be a supported electrode catalyst, such as an electrode catalyst on a particulate support, such as an electrode catalyst on carbon particles. In some embodiments, the electrode catalyst layer is electronically conductive, for instance due to the presence of carbon partides or another electronically conductive material, such as conductive particulates, typically metallic particulates, such as metallic electrode catalyst particles. Alternatively, the electrode catalyst layer may be electronically conductive due to the presence of metallic electrode catalyst particles.

The at least one electrode catalyst of the electrode catalyst layer may comprise one or more of Pt, Ir, Ni, Co, Pd, Ti, Sn, Ta, Nb, Sb, Pb, Mn, Ru and Fe, their oxides, and mixtures thereof.

In some embodiments, the electrode catalyst layer comprising the at least one electrode catalyst may be a first electrode catalyst layer having a first surface and an opposing second surface, such that the first surface of the first porous layer is in contact with the first surface of the reinforced polymer electrolyte membrane and the second surface of the first porous layer is in contact with the first surface of the first electrode catalyst layer. Preferably, the first surface of the at least one reinforced polymer electrolyte membrane may comprise a layer of ion exchange material comprising the membrane catalyst as discussed above as a component the at least one layer of ion exchange material of the composite electrolyte membrane.

Alternatively or additionally, a further electrode catalyst layer comprising the at least one electrode catalyst may be a second electrode catalyst layer having a first surface and an opposing second surface, such that the first surface of the second porous layer is in contact with the second surface of the reinforced polymer electrolyte membrane and the second surface of the second porous layer is in contact with the first surface of the second electrode catalyst layer. Preferably, the second surface of the at least one reinforced polymer electrolyte membrane may comprise a layer of ion exchange material comprising the membrane catalyst as discussed above as a component the at least one layer of ion exchange material of the composite electrolyte membrane.

In some embodiments, the first electrode, as a first electrode layer, has a first surface and an opposing second surface, and the first surface of the first porous layer is in contact with the first surface of the at least one reinforced polymer electrolyte membrane and the second surface of the first porous layer is in contact with the first surface of the first electrode. Preferably, the first surface of the at least one reinforced polymer electrolyte membrane may comprise a layer of ion exchange material comprising the membrane catalyst as discussed above as a component the at least one layer of ion exchange material of the composite electrolyte membrane.

Alternatively or additionally, a second electrode, as a second electrode layer may be provided having a first surface and an opposing second surface, and the first surface of the second porous layer is in contact with the first surface of the at least one reinforced polymer electrolyte membrane and the second surface of the second porous layer is in contact with the first surface of the second electrode. Preferably, the second surface of the at least one reinforced polymer electrolyte membrane may comprise a layer of ion exchange material comprising the membrane catalyst as discussed above as a component the at least one layer of ion exchange material of the composite electrolyte membrane.

Such membrane electrode assemblies may be used as membrane electrode assemblies in an electrolyzer or a fuel cell.

When the membrane electrode assemblies are membrane electrode assemblies in a fuel cell, the first and second electrode catalyst layers may have a pore size of less than or equal to about 100 nm. The first and second electrode catalyst layers may independently comprise one or more ion exchange materials, a catalyst support such as carbon black, and a catalyst supported on the catalyst support such as platinum.

Redox flow batteries, fuel cells and electrolyzers containing such membrane electrode assemblies are also within the scope of the present disclosure.

### EXAMPLES

### Test Procedures and Measurement Protocols Used in Examples

Unless stated otherwise, the temperature at which 0% RH is determined is 23° C.

### Bubble Point

The Bubble Point was measured according to the procedures of ASTM F316-86. Isopropyl alcohol was used as the wetting fluid to fill the pores of the test specimen. The Bubble Point is the pressure of air required to create the first continuous stream of bubbles detectable by their rise through the layer of isopropyl alcohol covering the microporous polymer matrix. This measurement provides an estimation of maximum pore size.

### Non-Contact Thickness

A sample of microporous polymer structure was placed over a flat smooth metal anvil and tensioned to remove wrinkles. The height of the microporous polymer structure on the anvil was measured and recorded using a non-contact Keyence LS-7010M digital micrometer. Next, the height of the anvil without the microporous polymer structure was recorded. The thickness of the microporous polymer structure was taken as a difference between micrometer readings with and without microporous structure being present on the anvil.

### Mass-Per-Area

Each microporous polymer structure was strained sufficiently to eliminate wrinkles, and then a 10 cm² piece was cut out using a die. The 10 cm² piece was weighed on a conventional laboratory scale. The mass-per-area (M/A) was then calculated as the ratio of the measured mass to the known area. This procedure was repeated 2 times and the average value of the M/A was calculated.

### Apparent Density of Microporous Polymer Structure

The apparent density of the microporous polymer structure was calculated using the non-contact thickness and mass-per-area data using the following formula:

$$Apparent {density}_{m i c r oporous polymer structure} = \frac{\{ M / {A}_{m i c r o p o rous polymer structure} \}}{\{ non - contact thickness \}} = [ g / cc ]$$

### Porosity of Microporous Polymer Structure

The porosity of the microporous polymer structure was calculated using the apparent density and skeletal density data using the following formula:

$${Porosity}_{micr oporous polymer structure} = \frac{\{ Apparent {density}_{micr oporous polymer structure} \}}{\{ Skeletal {density}_{micr oporous polymer structure} \}}$$

### Solids Concentration of Solutions of Ion Exchange Material (IEM)

Herein, the terms “solution” and “dispersion” are used interchangeably when referring to ion exchange materials (IEMs). This test procedure is appropriate for solutions in which the IEM is in proton form, and in which there are negligible quantities of other solids. A volume of 2 cubic centimeters of IEM solution was drawn into a syringe and the mass of the syringe with solution was measured via a balance in a solids analyzer (obtained from CEM Corporation, USA). The mass of two pieces of glass fiber paper (obtained from CEM Corporation, USA) was also measured and recorded. The IEM solution was then deposited from the syringe into the two layers of glass fiber paper. The glass fiber paper with the ionomer solution was placed into the solids analyzer and heated up to 160° C. to remove the solvent liquids. Once the mass of the glass fiber paper and residual solids stopped changing with respect to increasing temperature and time, it was recorded. It is assumed that the residual IEM contained no water (i.e., it is the ionomer mass corresponding to 0% RH). After that, the mass of the emptied syringe was measured and recorded using the same balance as before. The ionomer solids in solution was calculated according to the following formula:

$$\{ wt \% solids of IEM solution \} = \frac{\begin{matrix}\{ Mass of glass fiber paper with residual solids \} - \\ \{ Mass of glass fiber papar \}\end{matrix}}{\{ Mass of full syringe \} - \{ Mass of emptied syringe \}} = [ wt \% ]$$

### Equivalent Weight (EW) of an IEM

The following test procedure is appropriate for IEM comprised of a single ionomer resin or a mixture of ionomer resins that is in the proton form (i.e., that contains negligible amounts of other cations), and that is in a solution that contains negligible otherionic species, including protic acids and dissociating salts. If these conditions are not met, then prior to testing the solution must be purified from ionic impurities according to a suitable procedure as would be known to one of ordinary skill in the art, or the impurities must be characterized and their influence on the result of the EW test must be corrected for.

As used herein, the EW of an IEM refers to the case when the IEM is in its proton format 0% RH with negligible impurities. The IEM may comprise a single ionomer or a mixture of ionomers in the proton form. An amount of IEM solution with solids concentration determined as described above containing 0.2 grams of solids was poured into a plastic cup. The mass of the ionomer solution was measured via a conventional laboratory scale (obtained from Mettler Toledo, LLC, USA). Then, 5 ml of deionized water and 5 ml of 200 proof denatured ethanol (SDA 3C, Sigma Aldrich, USA) is added to ionomer solution in the cup. Then, 55 ml of 2N sodium chloride solution in water was added to the IEM solution. The sample was then allowed to equilibrate under constant stirring for 15 minutes. After the equilibration step, the sample was titrated with 1N sodium hydroxide solution. The volume of 1N sodium hydroxide solution that was needed to neutralize the sample solution to a pH value of 7 was recorded. The EW of the IEM (EWIEM) was calculated as:

$$E {W}_{IEM} = \frac{\{ Mass of IEM solution \} \times \{ wt \% solids of IEM solution \}}{\{ Volume of NaOH solution \} \times \{ Normality of NaOH solution \}} = [ \frac{g}{mole eq .} ]$$

When multiple IEMs were combined to make a composite membrane, the average EW of the IEMs in the composite membrane was calculated using the following formula:

$$E {W}_{IEM \_ average} = {[ \frac{\{ Mass fraction of IEM 1 \}}{\{ E {W}_{IEM , 1} \}} + \frac{\{ Mass fraction of IEM 2 \}}{\{ E {W}_{IEM , 2} \}} + … \cdot \frac{\{ Mass fraction of IEM N \}}{\{ E {W}_{IEM , N} \}} ]}^{- 1} = [ \frac{g}{mole eq .} ] ,$$

where the mass fraction of each IEM is with respect to the total amount of all IEMs. This formula was used both for composite membranes containing ionomer blends and for composite membranes containing ionomer layers.

### Equivalent Volume (EV) of Ion Exchange Material

As used herein, the Equivalent Volume of the IEM refers to the EV if that IEM were pure and in its proton form at 0% RH, with negligible impurities. The EV was calculated according to the following formula:

$$E {V}_{E M} = \frac{\{ Equivalent Weight of IEM \}}{\{ Volumetric density of IEM at 0 \% RH \}} = [ \frac{c c}{mole eq .} ]$$

The Equivalent Weight of each IEM was determined in accordance with the procedure described above. The IEMs used in these application were perfluorosulfonic acid ionomer resins the volumetric density of perfluorosulfonic acid ionomer resin was taken to be 1.9 g/cc at 0% RH.

### Thickness of Composite Electrolyte Membrane

The composite electrolyte membranes were equilibrated in the room in which the thickness was measured for at least 1 hour prior to measurement. Composite electrolyte membranes were left attached to the substrates on which the composite electrolyte membranes were coated. For each sample, the composite electrolyte membrane on its coating substrate was placed on a smooth, flat, level marble slab. A thickness gauge (obtained from Heidenhain Corporation, USA) was brought into contact with the composite membrane and the height reading of the gauge was recorded in six different spots arranged in grid pattern on the membrane. Then, the sample was removed from the substrate, the gauge was brought into contact with the substrate, and the height reading was recorded again in the same six spots. The thickness of the composite membrane at a given relative humidity (RH) in the room was calculated as a difference between height readings of the gauge with and without the composite membrane being present. The local RH was measured using an RH probe (obtained from Fluke Corporation). The thickness at 0% RH was calculated using the following general formula:

$$Composite membrane thickness at 0 \% RH == ( \frac{\begin{matrix}Composite membrane thickness at room RH - \\ \frac{M / {A}_{microporous polymer structure}}{{Density}_{microporous polymer structure}}\end{matrix}}{1 + \frac{{λ}_{r o o m R H}}{E {W}_{ionomer \_ average}} * \frac{Molecular {weight}_{w a t e r}}{{Density}_{w a t e r}} * {Density}_{i o n o m e r}} ) ** ( 1 + \frac{{λ}_{R H = 0 \%}}{E {W}_{i o n o m e {r}_{average}}} * \frac{Molecular {weight}_{w a t e r}}{{Density}_{w a t e r}} * {Density}_{i o n o m e r} ) + \frac{M / {A}_{microporous polymer structure}}{{Density}_{microporous polymer structure}} == [ micron ]$$

where the parameter λ corresponds to the water uptake of the Ion Exchange Material in terms of moles of water per mole of acid group at a specified RH. For PFSA ionomer, the values for/at any RH in the range from 0 to 100% in gas phase were calculated according the following formula:

$$λ = 80.239 \times R {H}^{6} - 38.717 \times R {H}^{5} - 164.451 \times R {H}^{4} + 208.509 \times R {H}^{3} - 91.052 \times R {H}^{2} + 21. 740 \times R {H}^{1} + 0.084$$

### Microporous Polymer Matrix (MPM) Volume Content of Composite Electrolyte Membrane

The volume % of the Microporous Polymer Matrix in each Composite Membrane was calculated according to the following formula:

$$\% {Vol}_{M P M} = \frac{( \frac{M / {A}_{microporous polymer structure}}{Matrix skeletal {density}_{Pmicroporous polymer structure}} )}{Composite Membrane thickness at 0 \% RH} = [ \% ]$$

The Microporous Polymer Matrices used in these examples were ePTFE and track etched porous polycarbonate. The matrix skeletal density of ePTFE was taken to be 2.25 g/cc and of track etched porous polycarbonate was taken to be 1.20 g/cc.

### Acid Content of Composite Electrolyte Membrane

Acid content of composite membranes was calculated according to the following formula:

$$Acid Content = \frac{( \begin{matrix}Composite Membrane thickness at 0 \% RH - \\ \frac{M / {A}_{microporous polymer structure}}{Matrix {Density}_{microporous polymer structure}}\end{matrix} ) \times {Density}_{ionomer}}{E {W}_{ionomer}} \times \frac{1}{Composite Membrane thickness at 0 \% RH} = [ \frac{mole eq}{cc} ]$$

### Burst Pressure Test of Composite Electrolyte Membrane

The mechanical strength of a composite electrolyte membrane prepared in accordance with the present invention was measured by subjecting a sample to a load pressure.

A sample of the membrane is secured between two steel plates with a 10 mm aperture in the top plate. The system is pressurized from below to stress the membrane biaxially as it domes up through the aperture. The pressure is increased in 5 psi increments with a 5 sec hold between each level until the membrane fails. The pressure at which failure occurred is recorded as the burst pressure. This procedure is repeated four times to calculate an average burst pressure and standard deviation.

### Average Puncture Pressure Failure Test

A sample was placed between two porous carbon electrodes (Sigracet 39AA Carbon Paper) and loaded on an Instron model 5542, with electrically isolated 14 mm diameter gold-plated cylindrical platens. The sample and electrodes area were oversized compared to the platens and extended beyond the platen to eliminate edge effects on puncture. The sample area was oversized compared to the electrodes area to prevent electrodes from touching and creating an electronic short that does not path through the sample. Electrical resistance across the membrane is measured by a Keithley 580 Micro-Ohmmeter connected to the top and bottom platens. The top platen was lowered at ambient conditions at a rate of 1 mm/min while compressive mechanical load is applied to the samples and electrical resistance measured across the sample were constantly recorded until 444.8 N (100 lbf) was applied; where a higher compression pressure may be accessed with alternative instrumentation or smaller platen active area. Membrane puncture is defined as the pressure when electrical resistance drops below 18,000 ohms, representing physical contact of the electrodes or electrode fibers through the sample. Five replicates were tested for each sample and the average of the five runs is reported as the average puncture pressure. Puncture pressure is dependent on electrode material and may significantly increase or decrease if alternative electrode materials are used.

$$Puncture Pressure = \frac{\{ Force at Failure \}}{\{ Platen Surface Area \}} = [ psi ]$$

### EXAMPLES

The composite electrolyte membranes of the present disclosure may be better understood by referring to the following non-limiting examples.

To determine characteristics such as acid content, volume, and puncture resistance of the composite membrane and properties of the test procedures and measurement protocols were performed as described above. Table 1 illustrates the properties of composite membranes according to embodiments of the invention as well as comparative examples. Table 2 illustrates properties of the microporous polymer structure used in various test procedures in five series of examples in accordance with some aspects of the invention as well as comparative examples.

Ion Exchange Materials Manufactured in Accordance with Aspects of the Present Disclosure for All Examples

All ion exchange materials used in the following examples are perfluorosulfonic acid (PFSA) based ionomers with the specified equivalent weight (EW) in Table 1. All ionomers prior to manufacturing of composite membranes were in the form of solutions based on water and ethanol mixtures as solvent with water content in solvent phase being less than 50%.

A commonly known ion exchange material was used to produce a composite membrane of the present disclosure. A preferable example is a solution obtained by dispersing or dissolving a solid PFSA ionomer which contains the units —(CF₂CF₂)ₐ— and —(CF₂CXF)_{b}— in which X is —O—(CF₂C(CF₃)FO)ₙ—CF₂CF₂SO₃H, represented by the following general formula (wherein a: b=1:1 to 9:1 and n=0, 1, or 2) in a solvent.

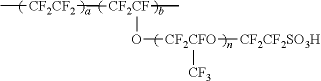

In some aspects, the solvent is selected from the group consisting of: water, alcohols such as methanol, ethanol, propanol, n-butylalcohol, isobutylalcohol, sec-butylalcohol, and tert-butylalcohol; pentanol and its isomers; hexanol and its isomers; hydrocarbon solvents such as n-hexane; ether-based solvents such as tetrahydrofuran and dioxane; sulfoxide-based solvents such as dimethylsulfoxide and diethylsulfoxide; formamide-based solvents such as N, N-dimethylformamide and N, N-diethylformamide; acetamide-based solvents such as N, N-dimethylacetamide and N,N-diethylacetamide; pyrrolidone-based solvents such as N-methyl-2-pyrrolidone and N-vinyl-2-pyrrolidone; 1,1,2,2-tetrachloroethane; 1,1,1,2-tetrachloroethane; 1,1,1-trichloroethane; 1,2-dichloroethane; trichloroethylene; tetrachloroethylene; dichloromethane; and chloroform. In the present disclosure, the solvent is optionally selected from the group consisting of water, methanol, ethanol, propanol. Water and the above solvents may be used alone or in combinations of two or more.

### Comparative Example 1

An ePTFE membrane 1 with mass per area of 4 g/m², a thickness of 13.3 μm, an apparent density of 0.26 g/cc and a bubble point of 55.5 psi was hand strained to eliminate wrinkles and restrained in this state by a metal frame. Next, a first laydown of PSFA solution with EV=379 cc/mole eq (obtained from Asahi Glass Company, Japan), solution composition of 34.87% water, 48.09% ethanol, 17.04% solids, was coated onto the top side of a polymer sheet substrate. The polymer sheet substrate (obtained from DAICEL VALUE COATING LTD., Japan) comprises PET and a protective layer of cyclic olefin copolymer (COC), and was oriented with the COC side on top. The IEM (PFSA solution) coating was accomplished using a Meyer bar with theoretical wet coating thickness of 3 mils. While the coating was still wet, the ePTFE membrane 1 previously restrained on metal frame was laminated to the coating, whereupon the IEM solution imbibed into the pores. This composite material was subsequently dried in a convection oven with air inside at a temperature of 165° C. Upon drying, the microporous polymer structure (ePTFE membrane) became fully imbibed with the IEM. The IEM also formed a layer between the bottom surface of the microporous polymer substrate and the polymer sheet substrate. On the second laydown, the same IEM, in solution composition of 38% water, 57.7% ethanol, 4.3% solids, was coated onto the top surface of the composite material (the surface opposite the polymer sheet substrate) using a drawdown bar with theoretical wet coating thickness of 3 mil. The composite material was then dried again at 165° C., at which point it was largely transparent, indicating a full impregnation of the microporous polymer structure. The multilayer composite membrane was fully occlusive and had a layer of IEM on each side of the microporous polymer matrix. The resulting multilayer composite membrane had thickness at 0% RH of 6.5 micrometer, 28% by volume occupied by microporous polymer structure, and acid content of 1.9 meq/cc. The multilayer composite membrane has no porous layers.

### Example 1

An ePTFE membrane with mass per area of 4 g/m², a thickness of 13.3 μm, an apparent density of 0.26 g/cc and a bubble point of 55.5 psi was hand strained to eliminate wrinkles and restrained in this state by a metal frame. Next, a first laydown of PSFA solution with EV=379 cc/mole eq (obtained from Asahi Glass Company, Japan), solution composition of 34.87% water, 48.09% ethanol, 17.04% solids, was coated onto the top side of a polymer sheet substrate. The polymer sheet substrate (obtained from DAICEL VALUE COATING LTD., Japan) comprises PET and a protective layer of cyclic olefin copolymer (COC), and was oriented with the COC side on top. The IEM (PFSA solution) coating was accomplished using a Meyer bar with theoretical wet coating thickness of 3 mils. While the coating was still wet, the ePTFE membrane 1 previously restrained on metal frame was laminated to the coating, whereupon the IEM solution imbibed into the pores. This composite material was subsequently dried in a convection oven with air inside at a temperature of 165° C. Upon drying, the microporous polymer structure (ePTFE membrane) became fully imbibed with the IEM. The IEM also formed a layer between the bottom surface of the microporous polymer substrate and the polymer sheet substrate. On the second laydown, the same IEM, in solution composition of 38% water, 57.7% ethanol, 4.3% solids, was coated onto the top surface of the composite material (the surface opposite the polymer sheet substrate) using a drawdown bar with theoretical wet coating thickness of 3 mil. The composite material was then dried again at 165° C., at which point it was largely transparent, indicating a full impregnation of the microporous polymer structure. The multilayer composite membrane was fully occlusive and had a layer of IEM on each side of the microporous polymer matrix. The resulting multilayer composite membrane had thickness at 0% RH of 6.5 micrometer, 28% by volume occupied by microporous polymer structure, and acid content of 1.9 meq/cc.

This multilayer composite membrane was then pressed between layers of a woven PTFE material at 160 degrees C. for 90 seconds under 960 pounds per square inch of pressure to form the final membrane-protective layer composite.

The filament is expanded polytetrafluoroethylene (ePTFE) having a titer of 200 denier, twisted at 32 twists per inch (TPI) in the Z direction. The filament is available from W. L. Gore and Associates, Inc. Elkton, MD part number V112407. The filament was woven on a Dornier rapier loom into a plain weave scrim cloth using 4 harnesses outfitted with all leno heddles. A scrim was produced using 15 leno paired ends per inch (ppi) (i.e., 30 single filaments at epi) in the warp direction and 15 picks perinch (ppi) in the weft direction. No finish or weaving processing aids were applied to the filament or woven cloth. The selvedge from both sides of the cloth was removed to produce the inventive samples.

### Comparative Example 2

An ePTFE membrane 1 with mass per area of 2 g/m², a thickness of 6.83 μm, an apparent density of 0.34 g/cc and a bubble point of 86.2 psi was hand strained to eliminate wrinkles and restrained in this state by a metal frame. Next, a first laydown of PSFA solution with EV=379 cc/mole eq (obtained from Asahi Glass Company, Japan), solution composition of 33.0% water, 52.2% ethanol, 14.8% solids, was coated onto the top side of a polymer sheet substrate. The polymer sheet substrate (obtained from DAICEL VALUE COATING LTD., Japan) comprises PET and a protective layer of cyclic olefin copolymer (COC), and was oriented with the COC side on top. The IEM (PFSA solution) coating was accomplished using a Meyer bar with theoretical wet coating thickness of 3 mils. While the coating was still wet, the ePTFE membrane 1 previously restrained on metal frame was laminated to the coating, whereupon the IEM solution imbibed into the pores. This composite material was subsequently dried in a convection oven with air inside at a temperature of 165° C. Upon drying, the microporous polymer structure (ePTFE membrane) became fully imbibed with the IEM. The IEM also formed a layer between the bottom surface of the microporous polymer substrate and the polymer sheet substrate. On the second laydown, the same IEM, in solution composition of 38.0% water, 57.7% ethanol, 4.3% solids, was coated onto the top surface of the composite material (the surface opposite the polymer sheet substrate) using a drawdown bar with theoretical wet coating thickness of 1.5 mil. The composite material was then dried again at 165° C., at which point it was largely transparent, indicating a full impregnation of the microporous polymer structure. The multilayer composite membrane was fully occlusive and had a layer of IEM on each side of the microporous polymer matrix. The resulting multilayer composite membrane had thickness at 0% RH of 3.25 micrometers, 28% by volume occupied by microporous polymer structure, and acid content of 1.9 meq/cc. The multilayer composite membrane has no porous layers.

### Example 2

An ePTFE membrane 1 with mass per area of 2 g/m², a thickness of 6.83 μm, an apparent density of 0.34 g/cc and a bubble point of 86.2 psi was hand strained to eliminate wrinkles and restrained in this state by a metal frame. Next, a first laydown of PSFA solution with EV=379 cc/mole eq (obtained from Asahi Glass Company, Japan), solution composition of 33.0% water, 52.2% ethanol, 14.8% solids, was coated onto the top side of a polymer sheet substrate. The polymer sheet substrate (obtained from DAICEL VALUE COATING LTD., Japan) comprises PET and a protective layer of cyclic olefin copolymer (COC), and was oriented with the COC side on top. The IEM (PFSA solution) coating was accomplished using a Meyer bar with theoretical wet coating thickness of 3 mils. While the coating was still wet, the ePTFE membrane 1 previously restrained on metal frame was laminated to the coating, whereupon the IEM solution imbibed into the pores. This composite material was subsequently dried in a convection oven with air inside at a temperature of 165° C. Upon drying, the microporous polymer structure (ePTFE membrane) became fully imbibed with the IEM. The IEM also formed a layer between the bottom surface of the microporous polymer substrate and the polymer sheet substrate. On the second laydown, the same IEM, in solution composition of 38.0% water, 57.7% ethanol, 4.3% solids, was coated onto the top surface of the composite material (the surface opposite the polymer sheet substrate) using a drawdown bar with theoretical wet coating thickness of 1.5 mil. The composite material was then dried again at 165° C., at which point it was largely transparent, indicating a full impregnation of the microporous polymer structure. The multilayer composite membrane was fully occlusive and had a layer of IEM on each side of the microporous polymer matrix. The resulting multilayer composite membrane had thickness at 0% RH of 3.25 micrometer, 28% by volume occupied by microporous polymer structure, and acid content of 1.9 meq/cc.

This multilayer composite membrane was then pressed between layers of a woven PTFE material at 160 degrees C. for 90 seconds under 960 pounds per square inch of pressure to form the final membrane-protective layer composite.

The filament is expanded polytetrafluoroethylene (ePTFE) having a titer of 200 denier, twisted at 32 twists per inch (TPI) in the Z direction. The filament is available from W. L. Gore and Associates, Inc. Elkton, MD part number V112407. The filament was woven on a Dornier rapier loom into a plain weave scrim cloth using 4 harnesses outfitted with all leno heddles. A scrim was produced using 15 leno paired ends per inch (ppi) (i.e., 30 single filaments at epi) in the warp direction and 15 picks per inch (ppi) in the weft direction. No finish or weaving processing aids were applied to the filament or woven cloth. The selvedge from both sides of the cloth was removed to produce the inventive samples.

### Comparative Example 3

A laydown of PSFA solution with EV=379 cc/mole eq (obtained from Asahi Glass Company, Japan), solution composition of 41% water, 53% ethanol, 6% solids, was coated onto the top side of a polymer sheet substrate. The polymer sheet substrate (obtained from DAICEL VALUE COATING LTD., Japan) comprises PET and a protective layer of cyclic olefin copolymer (COC), and was oriented with the COC side on top. The IEM (PFSA solution) coating was accomplished using a Meyer bar with theoretical wet coating thickness of 7 mils. This cast film was subsequently dried in a convection oven with air inside at a temperature of 165° C. The cast film is not a reinforced polymer electrolyte membrane because it does not contain a microporous polymer structure. The cast film also has no porous layers.

### Comparative Example 4

A laydown of PSFA solution with EV=379 cc/mole eq (obtained from Asahi Glass Company, Japan), solution composition of 41% water, 53% ethanol, 6% solids, was coated onto the top side of a polymer sheet substrate. The polymer sheet substrate (obtained from DAICEL VALUE COATING LTD., Japan) comprises PET and a protective layer of cyclic olefin copolymer (COC), and was oriented with the COC side on top. The IEM (PFSA solution) coating was accomplished using a Meyer bar with theoretical wet coating thickness of 7 mils. This cast film was subsequently dried in a convection oven with air inside at a temperature of 165° C. The cast film is not a reinforced polymer electrolyte membrane because it does not contain a microporous polymer structure.

The cast film was then placed on a layer of woven PTFE with the PSFA cast film in contact with the woven PTFE. The polymer sheet substrate comprising PET and a protective layer is then removed from the PFSA cast film. A further layer of woven PTFE is then applied so that the PSFA cast film is located between the two layers of woven PTFE. The multilayer composite membrane was then pressed at 160 degrees C. for 90 seconds under 960 pounds per square inch of pressure to form the final membrane-protective layer composite.

The layers of woven PTFE material are obtained from filaments of expanded polytetrafluoroethylene (ePTFE) having a titer of 200 denier, twisted at 32 twists per inch (TPI) in the Z direction. The filament is available from W. L. Gore and Associates, Inc. Elkton, MD part number V112407. The filament was woven on a Dornier rapier loom into a plain weave scrim cloth using 4 harnesses outfitted with all leno heddles. A scrim was produced using 15 leno paired ends per inch (ppi) (i.e., 30 single filaments at epi) in the warp direction and 15 picks per inch (ppi) in the weft direction. No finish or weaving processing aids were applied to the filament or woven cloth. The selvedge from both sides of the cloth was removed to produce the comparative sample.

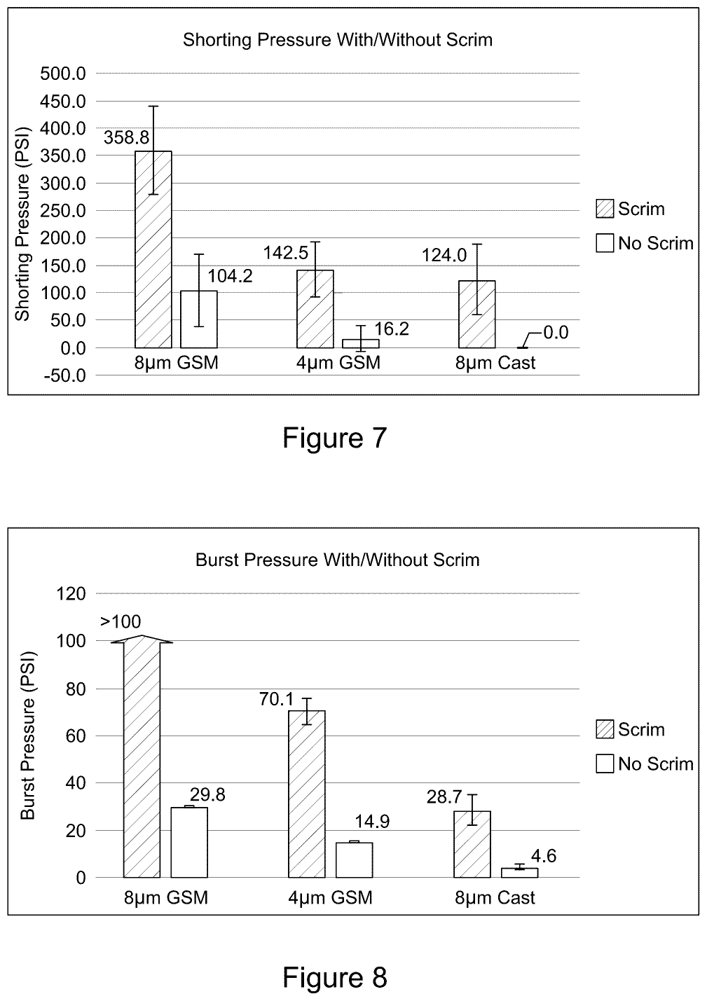

The properties of the composite electrolyte membranes of the examples are presented in Table 1 and plotted in FIGS. 7 and 8. The improvement of the shorting pressure is illustrated in FIG. 7, which shows a chart comparing the average shorting pressure of comparable membranes with the average shorting pressure of inventive composite electrolyte membranes. The improvement of the burst pressure is illustrated in FIG. 8, which shows a chart comparing the average burst pressure of comparable membranes with the average burst pressure of inventive composite electrolyte membranes.

From Table 1 and FIG. 8, the average failure pressure of an 8 μm sample with microporous polymer structure and two porous layers of scrim (Example 1) is more than the addition of an 8 μm sample with a microporous polymer structure in the reinforced polymer electrolyte membrane and no porous layers (Comparative Example 1) and an 8 μm sample without a microporous polymer structure and with two porous layers of scrim (Comparative Example 4). A similar effect can be seen for Average Burst Pressure looking at Table 1 and FIG. 8, where Example 1 is stronger than the limits of the bursting test (100 psi), but Comparative Examples 1 and 4 do not achieve higher burst pressures than 30 psi. Both these sets of data show that the a combination of microporous polymer structure and porous layers together provide synergistic performance effects, a surprising and inventive result.

TABLE 1

| | | | | Average puncture | | Burst | |
|---|---|---|---|---|---|---|---|
| | | | | pressure failure | | Pressure | |
| Membrane | | | | (PSI) | | (PSI) | |
| Name | PEM | Ionomer | Porous layer | Avg | Std | Avg | Std |
| Example 1 | 8 μm reinforced | PFSA | PTFE Scrim | 358.8 | 80.5 | >100 | — |
| | PEM | 379 cc/mole | | | | | |
| | | eq | | | | | |
| Example 2 | 4 μm reinforced | PFSA | PTFE Scrim | 142.5 | 50.9 | 70.1 | 5.2 |
| | PEM | 379 cc/mole | | | | | |
| | | eq | | | | | |
| Comparative | 8 μm reinforced | PFSA | No | 104.2 | 66.0 | 30.0 | 0.0 |
| Example 1 | PEM | 379 cc/mole | | | | | |
| | | eq | | | | | |
| Comparative | 4 μm reinforced | PFSA | No | 16.2 | 23.5 | 14.9 | 0.0 |
| Example 2 | PEM | 379 cc/mole | | | | | |
| | | eq | | | | | |
| Comparative | 8 μm cast PEM | PFSA | No | 0.0 | 0.0 | 4.6 | 1.1 |
| Example 3 | | 379 cc/mole | | | | | |
| | | eq | | | | | |
| Comparative | 8 μm cast PEM | PFSA | PTFE Scrim | 124.0 | 63.5 | 28.7 | 6.5 |
| Example 4 | | 379 cc/mole | | | | | |
| | | eq | | | | | |

From Table 1 and FIGS. 7 and 8, it can be seen that thinner membranes such as the 4 μm reinforced polymer electrolyte membrane in Example 2 and Comparative Example 2 can significantly benefit from the addition of porous layers of scrim for shorting protection and additional strength in a burst test. Additionally, for such thin membrane designs, the microporous polymer structure is a necessary component of the polymer electrolyte membrane to handle and process the ion exchange membrane into the composite electrolyte membrane with the porous layer(s). Without both the microporous polymer structure and the porous layers, the performance of these composite electrolyte membranes would be significantly reduced and the constructions might not even be feasible.

While the invention has been described in detail, modifications within the spirit and scope of the invention will be readily apparent to the skilled artisan. It may be understood that aspects of the invention and portions of various embodiments and various features recited above and/or in the appended claims may be combined or interchanged either in whole or in part. In the foregoing descriptions of the various embodiments, those embodiments which refer to another embodiment may be appropriately combined with other embodiments as will be appreciated by the skilled artisan. Furthermore, the skilled artisan will appreciate that the foregoing description is by way of example only, and is not intended to limit the invention.

1. A composite electrolyte membrane (100) for an electrochemical device, comprising:
a) at least one reinforced polymer electrolyte membrane (110) having a first surface (112) and an opposing second surface (114), said at least one reinforced polymer electrolyte membrane comprising:
a microporous polymer structure (120) and an ion exchange material (125), in which the ion exchange material is at least partially embedded within the microporous polymer structure to render the microporous polymer structure occlusive; and
b) a plurality of porous layers comprising at least a first porous layer (130) and a second porous layer (140),
the first porous layer having a first surface (132) and an opposing second surface (136) such that the first surface (132) of the first porous layer (130) is adjacent to the first surface (112) of the at least one reinforced polymer electrolyte membrane (110), wherein the first porous layer (130) has a plurality of pores (136) having a pore size in the range of from 5 micrometers to 5000 micrometers, and the plurality of pores provide one or more passages extending between the first and second surfaces (132, 134) of the first porous layer (130),
the second porous layer (140) having a first surface (142) and an opposing second surface (144) such that the first surface (142) of the second porous layer (140) is adjacent to the second surface (114) of the at least one reinforced polymer electrolyte membrane (110), wherein the second porous layer (140) has a plurality of pores (146) having a pore size in the range of from 5 micrometers to 5000 micrometers, and the plurality of pores (146) provide one or more passages extending through the second porous layer (140) between the first and second surfaces (142, 144) of the second porous layer (140).

2. The composite electrolyte membrane (100) according to claim 1, wherein the microporous polymer structure is fully embedded with the ion exchange material.

3. The composite electrolyte membrane (100) of claim 1 or claim 2 wherein the microporous polymer structure (120) of the reinforced polymer electrolyte membrane (110) has a first surface (121) and an opposing second surface (122); and wherein at least one layer of ion exchange material (126, 127) is present on at least one of the first surface and the second surface (121, 122) of the microporous polymer structure (120).

4. The composite electrolyte membrane (100) of claim 3, wherein a first layer (126) of ion exchange material (125) is present on the first surface (121) of the microporous polymer structure (120) and a second layer (127) of ion exchange material (125) is present on the second surface (122) of the microporous polymer structure (120).

5. The composite electrolyte membrane (100) of claim 3 or claim 4, wherein at least one further layer (128) of ion exchange material (125) is present on one or both of the first layer of ion exchange material and a second layer of ion exchange material.

6. The composite electrolyte membrane (100) of any of claims 3 to 5, wherein one or more of the layers of ion exchange material further comprise at least one membrane catalyst (150).

7. The composite electrolyte membrane (100) of claim 6, wherein the at least one membrane catalyst comprises a first membrane catalyst (150) comprising one or more of Pt, Ir, Ni, Co, Pd, Ti, Sn, Ta, Nb, Sb, Pb, Mn, Ru and Fe, their oxides and mixtures thereof.

8. The composite electrolyte membrane (100) of claims 6 and 7, wherein the at least one membrane catalyst comprises a first membrane catalyst and the first layer (126) of ion exchange material comprises the first membrane catalyst (150).

9. The composite electrolyte membrane (100) of any one of claims 6 to 8, wherein the at least one membrane catalyst comprises a first membrane catalyst and the second layer (127) of ion exchange material comprises the first membrane catalyst (150).

10. The composite electrolyte membrane (100) of claims 5 to 7, wherein the at least one membrane catalyst comprises a first membrane catalyst and the at least one further layer (128) of ion exchange material comprises the first membrane catalyst (150).

11. The composite electrolyte membrane (100) of any one of claims 5 to 10, wherein the at least one membrane catalyst is present on a support, such as a carbon particulate.

12. The composite electrolyte membrane (100) of any of the preceding claims, wherein one or both of the first and second porous layers (130, 140) is attached to the reinforced polymer electrolyte membrane (110).

13. The composite electrolyte membrane (100) of any of claims 3 to 12, wherein a portion of one or both of the first and second porous layers (130, 140) is partially embedded in the at least one layer of ion exchange material.

14. The composite electrolyte membrane (100) of any of the preceding claims, wherein the at least one reinforced polymer electrolyte membrane (110) comprises two or more microporous polymer structures (120).

15. The composite electrolyte membrane (100) of claim 14 wherein a pair of adjacent microporous polymer structures are separated by a layer of ion exchange material.

16. The composite electrolyte membrane (100) of any one of claims 3 to 11, wherein the at least one layer of ion exchange material has a thickness at 0% RH in the range of from about 0.5 μm to about 20 μm or from about 0.5 μm to about 15 μm or from about 0.5 μm to about 12 μm or from about 0.5 μm to about 8 μm or from about 0.5 μm to about 5 μm or from about 2 μm to about 5 μm.

17. The composite electrolyte membrane (100) of any of the preceding claims, wherein the microporous polymer structure in which the ion exchange material has been at least partially embedded to render the microporous polymer structure occlusive has a thickness at 0% RH in the range of from about 0.5 μm to about 30 μm or from about 0.5 μm to about 21 μm or from about 0.5 μm to about 10 μm or from about 0.5 μm to about 8 μm or from about 0.5 μm to about 6 μm or from about 2 μm to about 30 μm or from about 2 μm to about 21 μm or from about 2 μm to about 10 μm or from about 2 μm to about 8 μm or from about 2 μm to about 6 μm.

18. The composite electrolyte membrane (100) of any one of claims 1 to 16, wherein the microporous polymer structure in which the ion exchange material has been at least partially embedded to render the microporous polymer structure occlusive has a thickness at 0% RH in the range of from about 30 μm to about 100 μm or from about 30 μm to about 250 μm or from about 30 μm to about 500 μm.

19. The composite electrolyte membrane (100) of any of the preceding claims, wherein the microporous polymer structure comprises at least one fluorinated polymer.

20. The composite electrolyte membrane (100) according to claim 19, wherein the at least one fluorinated polymer is polytetrafluoroethylene (PTFE), poly(ethylene-co-tetrafluoroethylene) (EPTFE), expanded polytetrafluoroethylene (ePTFE), polyvinylidene fluoride (PVDF), expanded polyvinylidene fluoride (ePVDF), expanded poly(ethylene-co-tetrafluoroethylene) (eEPTFE) or mixtures thereof.

21. The composite electrolyte membrane (100) according to claim 19 or claim 20, wherein the fluorinated polymer is expanded polytetrafluoroethylene (ePTFE).

22. The composite electrolyte membrane (100) according to any one of claims 1 to 18, wherein the microporous polymer structure comprises at least one hydrocarbon polymer.

23. The composite electrolyte membrane (100) according to claim 22, wherein at least one hydrocarbon polymer comprises polyethylene, polypropylene, polycarbonate, polystyrene, or mixtures thereof.

24. The composite electrolyte membrane (100) according to any one of claims 19 to 23, wherein the microporous polymer structure, before the ion exchange material has been at least partially embedded, has a thickness at 0% RH in the range of from about 2 μm to about 150 μm or from about 2 μm to about 100 μm or from about 2 μm to about 70 μm or from about 2 μm to about 40 μm or from about 2 μm to about 20 μm.

25. The composite electrolyte membrane (100) according to any one of claims 19 to 24, wherein the microporous polymer structure, before the ion exchange material has been at least partially embedded, has a mass per area in the range of from about 0.5 g/m² to about 100 g/m² or from 0.5 g/m² to about 30 g/m² or from about 0.5 g/m² to about 21 g/m² or from about 0.5 g/m² to about 10 g/m² or from about 0.5 g/m² to about 8 g/m² or from about 0.5 g/m² to about 6 g/m² or from about 2 g/m² to about 30 g/m² or from about 2 g/m² to about 21 g/m² or from about 2 g/m² to about 10 g/m² or from about 2 g/m² to about 8 g/m² or from about 2 g/m² to about 6 g/m² or from about 30 g/m² to about 100 g/m² or from about 30 g/m² to about 80 g/m² or from about 30 g/m² to about 60 g/m².

26. The composite electrolyte membrane (100) of any of the preceding claims wherein the ion exchange material comprises at least one ionomer.

27. The composite electrolyte membrane (100) according to claim 26, wherein the at least one ionomer comprises a proton conducting polymer.

28. The composite electrolyte membrane (100) according to claim 27, wherein the proton conducting polymer comprises perfluorosulfonic acid.

29. The composite electrolyte membrane (100) according to any one of claims 26 to 28, wherein the at least one ionomer has a density not lower than about 1.9 g/cc at 0% relative humidity.

30. The composite electrolyte membrane (100) according to any preceding claim, wherein the average equivalent volume of the ion exchange material is from about 240 cc/mole eq to about 1000 cc/mole eq or the average equivalent volume of the ion exchange material is from about 240 cc/mole eq to about 650 cc/mole eq or the average equivalent volume of the ion exchange material is from about 240 cc/mole eq to about 475 cc/mole eq or the average equivalent volume of the ion exchange material is from about 350 cc/mole eq to about 475 cc/mole eq.

31. The composite electrolyte membrane (100) according to any preceding claim, wherein the reinforced polymer electrolyte membrane (110) has a thickness in the range of from 2 micrometer to 500 micrometer.

32. The composite electrolyte membrane (100) according to any preceding claim, wherein the reinforced polymer electrolyte membrane has a thickness in the range of from 4 micrometer to 30 micrometer.

33. The composite electrolyte membrane (100) according to any of the preceding claims, wherein each said plurality of porous layers may be independently selected from woven material and non-woven material, such as a mesh, knitted material, paper, felt, mat or cloth.

34. The composite electrolyte membrane (100) of claim 33 wherein each said plurality of porous layers is woven material.

35. The composite electrolyte membrane (100) according to any of the preceding claims, wherein each said plurality of porous layers comprise fluorinated polymer.

36. The composite electrolyte membrane (100) according to claim 35, wherein the fluorinated polymer is polytetrafluoroethylene (PTFE), poly(ethylene-co-tetrafluoroethylene) (EPTFE), polyvinylidene fluoride (PVDF) or mixtures thereof.

37. The composite electrolyte membrane (100) according to claim 35 or claim 36, wherein the fluorinated polymer is polytetrafluoroethylene (PTFE).

38. The composite electrolyte membrane (100) according to any one of claims 1 to 34, wherein a porous layer of the plurality of porous layers comprises hydrocarbon polymer.

39. The composite electrolyte membrane (100) according to claim 38, wherein hydrocarbon polymer comprises polyethylene, polypropylene, polycarbonate, polystyrene, or mixtures thereof.

40. The composite electrolyte membrane (100) according to any one of claims 1 to 34, wherein a porous layer of the plurality of porous layers comprises glass fiber.

41. The composite electrolyte membrane (100) according to any one of claims 1 to 34, wherein a porous layer of the plurality of porous layers comprises ceramic material.

42. The composite electrolyte membrane (100) according to claim 41, wherein the ceramic material comprises silica, zirconia, alumina, calcium oxide, magnesium oxide, boron oxide, sodium oxide, potassium oxide, or any mixtures thereof.

43. The composite electrolyte membrane (100) of any one of the preceding claims, wherein the pore size of each said plurality of porous layers is in the range of from 100 microns to 2000 micrometers or from 500 micrometers to 1500 micrometers.

44. The composite electrolyte membrane (100) of any one of the preceding claims, wherein each said plurality of porous layers has an air permeability of greater than 6000 l/hr at a differential pressure of 12 mbar for an open area of 2.99 cm².

45. The composite electrolyte membrane (100) according to any one of the preceding claims, wherein each said plurality of porous layers has an open area porosity of from 0.80 to 0.98.

46. The composite electrolyte membrane (100) according to any of the preceding claims, wherein each said plurality of porous layers is non-conductive.

47. The composite electrolyte membrane (100) according to any one of the preceding claims, wherein each of said plurality of porous layers has a thickness at 0% RH in the range of from about 15 μm to about 500 μm or from about 15 μm to about 250 μm or from about 15 μm to about 200 μm or from about 15 μm to about 150 μm or from about 15 μm to about 100 μm or from about 15 μm to about 50 μm or from about 30 μm to about 500 μm or from about 30 μm to about 250 μm or from about 30 μm to about 150 μm or from about 30 μm to about 100 μm or from about 30 μm to about 50 μm or from about 50 μm to about 500 μm or from about 50 μm to about 250 μm or from about 50 μm to about 200 μm or from about 50 μm to about 150 μm or from about 50 μm to about 100 μm.

48. The composite electrolyte membrane (100) according to any one of the preceding claims, wherein the composite electrolyte membrane has a thickness at 0% RH in the range of from about 30 μm to about 1500 μm or from about 30 μm to about 1250 μm or from about 30 μm to about 1100 μm or from about 30 μm to about 800 μm or from about 30 μm to about 500 μm or from about 30 μm to about 300 μm or from about 30 μm to about 250 μm or from about 30 μm to about 150 μm or from about 60 μm to about 1500 μm or from about 60 μm to about 1250 μm or from about 60 μm to about 1100 μm or from about 60 μm to about 800 μm or from about 60 μm to about 500 μm or from about 60 μm to about 300 μm or from about 60 μm to about 250 μm or from about 60 μm to about 150 μm or from about 100 μm to about 1500 μm or from about 100 μm to about 1250 μm or from about 100 μm to about 1100 μm or from about 100 μm to about 800 μm or from about 100 μm to about 500 μm or from about 100 μm to about 300 μm or from about 100 μm to about 250 μm or from about 100 μm to about 150 μm.

49. The composite electrolyte membrane (100) of any one of the preceding claims wherein the composite electrolyte membrane is an integral structure.

50. The composite electrolyte membrane (100) of any one of the preceding claims wherein the proton area specific resistance of the composite electrolyte membrane is ≥2500 MPa/(Ohm·cm²) or is ≥3500 MPa/(Ohm·cm²) or is ≥4000 MPa/(Ohm·cm²).

51. A membrane electrode assembly (200) for an electrochemical device, comprising:
at least one electrode comprising a first electrode (160); and
the composite electrolyte membrane according to any one of claims 1 to 50 adjacent to the at least one electrode such that the first porous layer (130) is between the first electrode (160) and the at least one reinforced polymer electrolyte membrane (110).

52. The membrane electrode assembly (200) according to claim 51, wherein the at least one electrode comprises a second electrode (170); and the second porous layer (140) is between the second electrode (170) and the reinforced polymer electrolyte membrane (110).

53. The membrane electrode assembly (200) according to claim 51 or claim 52, wherein the composite electrolyte membrane (100) is attached to the at least one electrode (160, 170).

54. The membrane electrode assembly (200) according to claim 51 or claim 52, wherein the composite electrolyte membrane (100) is pressed to the at least one electrode (160, 170).

55. The membrane electrode assembly (200) according to any one of claims 51 to 54, wherein the at least one electrode (160, 170) comprises a fiber or fibrous material.

56. The membrane electrode assembly (200) according to any one of claims 51 to 55, wherein the at least one electrode (160, 170) comprises carbon fibers or doped carbon fibers, optionally wherein the carbon fibers have a diameter from about 8 to about 30 μm.

57. The membrane electrode assembly (200) according claim 56, wherein the doped carbon fibers include N, P, S, or B, and mixtures thereof

58. The membrane electrode assembly (200) according to any one of claims 51 to 57, wherein the at least one electrode (160, 170) is selected from a felt, a paper, mat or a woven material.

59. The membrane electrode assembly (200) according to any one of claims 51 to 58, wherein the at least one electrode (160, 170) comprises an electrode catalyst layer comprising at least one electrode catalyst.

60. The membrane electrode assembly (200) according to claim 59, wherein the electrode catalyst layer comprises the at least one electrode catalyst on a support and ion exchange material.

61. The membrane electrode assembly (200) according to claim 59 or claim 60 wherein the at least one electrode catalyst comprises one or more of Pt, Ir, Ni, Co, Pd, Ti, Sn, Ta, Nb, Sb, Pb, Mn, Ru and Fe, their oxides, and mixtures thereof.

62. The membrane electrode assembly (200) according to any one of claims 59 to 61, wherein the electrode catalyst layer is electronically conductive.

63. The membrane electrode assembly (200) according to any one of claim 59 to claim 62, wherein the first electrode comprises the electrode catalyst layer comprising the at least one electrode catalyst.

64. The membrane electrode assembly (200) according to any one of claims 59 to 63, wherein the electrode catalyst layer has a first surface and an opposing second surface, such that the first surface (132) of the first porous layer (130) is in contact with the first surface (112) of the reinforced polymer electrolyte membrane (110) and the second surface (134) of the first porous layer (130) is in contact with the first surface of the electrode catalyst layer.

65. The membrane electrode assembly (200) according to any one of claims 51 to 63 wherein the first electrode (160) has a first surface and an opposing second surface, the first surface (132) of the first porous layer (130) is in contact with the first surface (112) of the at least one reinforced polymer electrolyte membrane (110) and the second surface (134) of the first porous layer (130) is in contact with the first surface of the first electrode (160).

66. The membrane electrode assembly (200) according to any one of claims 51 to 65, wherein the first surface of the at least one reinforced polymer electrolyte membrane (110) comprises a layer of ion exchange material comprising a membrane catalyst (150).

67. The membrane electrode assembly (200) according to any one of claims 59 to 66, wherein the membrane electrode assembly is an electrolyzer membrane electrode assembly.

68. The membrane electrode assembly (200) according to any one of claims 51 to 58 wherein the membrane electrode assembly is a redox flow battery membrane-electrode assembly.

69. The membrane electrode assembly (200) according to any one of claims 59 to 66 wherein the membrane electrode assembly is a fuel cell membrane-electrode assembly.

70. A fuel cell comprising the composite electrolyte membrane (100) according to any one of claims 1 to 50, or the membrane electrode assembly of claim 59 to 66 or 69.

71. A redox flow battery comprising the composite electrolyte membrane (100) according to any one of claims 1 to 50, or a membrane electrode assembly according to claim 51 to 66 or 68.

72. An electrolyzer comprising the composite electrolyte membrane (100) according to any one of claims 1 to 50, or a membrane electrode assembly according to claims 59 to 67.
